(19) United States
(12) Patent Application Publication
(10) Pub. No.: US 2009/0085960 A1
(43) Pub. Date: Apr. 2, 2009

(54) IMAGE FORMING METHOD AND INKJET RECORDING APPARATUS

(76) Inventors: Yasuko YAHIRO, Kanagawa-ken (JP); Naoki Kusunoki, Kanagawa-ken (JP)

Correspondence Address: BIRCH STEWART KOLASCH & BIRCH, PO BOX 747, FALLS CHURCH, VA, 22040-0747, US

(21) Appl. No.: 12/238,277

(22) Filed: Sep. 25, 2008

(30) Foreign Application Priority Data
Sep. 28, 2007 (JP) 2007-256720

(51) Int. Cl. B41J 2/015

(52) U.S. Cl. 347/21

(57) ABSTRACT

An image forming method of forming an image on an image forming body includes the steps of: applying a first treatment liquid onto the image forming body, the first treatment liquid having a first pH that is lower than an aggregation pH of the ink liquid; after the step of applying the first treatment liquid, depositing droplets of the ink liquid onto the image forming body on which the first treatment liquid has been applied, the droplets of the ink liquid being deposited according to the image data; after the step of depositing the droplets of the ink liquid, applying a second treatment liquid onto the image forming body on which the droplets of the ink liquid have been deposited, the second treatment liquid having a second pH that is lower than the aggregation pH of the ink liquid and lower than the first pH of the first treatment liquid; and after the step of applying the second treatment liquid, removing solvent derived from the ink liquid on the image forming body.

### BACKGROUND OF THE INVENTION

1. Field of the Invention

The present invention relates to an image forming method and inkjet recording apparatus, and more particularly, to image forming technology for forming dots by causing ink droplets to react with treatment liquid on an image forming body.

2. Description of the Related Art

At present, an inkjet recording apparatus has been used favorably as a generic image forming apparatus which outputs images captured by a digital camera, or duplicate images of a printed object, or the like. An inkjet recording apparatus can use various types of recording medium other than paper, such as a resin sheet, a metal sheet or the like. The most recent tendency is for there to be increasing demands for the output of high-quality images, regardless of the type of recording medium.

If ink droplets are ejected continuously onto a medium having permeable characteristics, such as normal paper, to form dots in such a manner that mutually adjacent dots are mutually overlapping, then a phenomenon known as bleeding (depositing interference) occurs in which the ink droplets which form mutually adjacent dots combine together due to the action of their surface tension and it therefore becomes impossible to form dots having a desired shape and size. When bleeding occurs, the shape of the dots is disturbed between dots of the same color, and the shape of the dots is also disturbed between dots of different colors, leading to the additional problem of color mixing.

In order to solve the problem of combination of dots, bleeding and color mixing caused by depositing interference of this kind, a two-liquid aggregation type of image forming method (two-liquid method) has been proposed, in which a treatment liquid having the function of causing the ink to aggregate is applied to the recording medium, and an aggregation reaction of the ink is generated on the recording medium.

Japanese Patent Application Publication No. 2004-10633 discloses a method which causes a pigment (coloring material) to aggregate in the vicinity of the surface of a recording medium and thus be present at high density in the vicinity of the surface of the recording medium. In this method, a liquid composition (treatment liquid) and an ink liquid are used, one of the liquid composition (treatment liquid) and the ink liquid being acidic, the other being alkaline. By this means, it is possible to obtain an ink image having excellent optical density, and bleeding and color mixing characteristics.

Moreover, Japanese Patent Application Publication No. 11-129461 discloses a method which provides a prescribed droplet ejection time differential between the ejection of ink droplets and the ejection of droplets of treatment liquid, thereby causing the treatment liquid to be deposited onto the ink when the ink has permeated to a prescribed range in the depth direction of the recording medium, and thus to react with and insolubilize the coloring material of the ink at a position inside the paper (recording medium). By this means, it is possible to obtain a desirable image having good scratch resistance and high quality.

Here, the two-liquid aggregation type of image forming method according to the related art will be described with reference to FIGS. 14A to 14F. In the two-liquid aggregation type of image forming method, firstly, a treatment liquid 2 is deposited on a recording medium 1 (FIG. 14A). FIG. 14A shows a mode where a treatment liquid 2 in the form of very fine liquid droplets is deposited onto the recording medium 1, but it is also possible to apply the treatment liquid onto the whole surface of the recording medium 1.

Next, an ink droplet 3 is deposited onto the treatment liquid film 2A which has been formed by the treatment liquid 2 deposited on the recording medium 1 (FIG. 14B). When the ink droplets 3 makes contact with the treatment liquid film 2A (when the treatment liquid 2 and the ink droplets 3 mix together), an aggregating reaction occurs in the ink droplets 3 and an aggregate material 5 is produced. FIG. 14C shows a state immediately after an aggregate 5 has been formed due to the occurrence of an aggregating reaction between the treatment liquid film 2A and the ink droplets 3 on the recording medium 1.

The time required for the ink droplet 3 to be aggregated completely is short compared to the speed at which the ink droplet 3 spreads to the prescribed size on the recording medium 1, and therefore it is not possible for the ink droplet 3 to spread sufficiently before the aggregating reaction of the ink droplet 3 has completed. In other words, an aggregate 5 having a smaller size than the desired size is formed.

FIG. 14D shows a state where the aggregating reaction of the ink droplet 3 has ended and the aggregate 5 and solvent are in a separated state. If the aggregating reaction ends before the ink droplet has spread sufficiently, then the aggregate 5 adheres to the recording medium 1 in a state where sufficient adhesive force cannot be obtained.

Next, a solvent removal step for removing surplus solvent (liquid) on the recording medium 1 is carried out (FIG. 14E). For the solvent removal step, it is suitable to use a method which absorbs and removes the solvent on the recording medium 1 by bringing an absorbing roller 7 into contact with the solvent on the recording medium 1.

From investigation carried out by the present inventors, it was found that when solvent is removed in a state where there is not sufficient adhesive force between the recording medium 1 and the aggregate 5, then as shown in FIG. 14F, a portion 5A of the aggregate (dot) adheres to the surface of the absorbing roller 7, a portion 5A of the aggregate peels away from the recording medium 1, and dot omissions occur.

Despite the existence of the latent problems described above, Japanese Patent Application Publication No. 2004-10633 and Japanese Patent Application Publication No. 11-129461 do not recognize these technical problems, and therefore do not mention technology for resolving the above-described problems.

### SUMMARY OF THE INVENTION

The present invention has been contrived in view of the aforementioned circumstances, an object thereof being to provide an image forming method and an inkjet recording apparatus whereby images of high quality having excellent fixing properties can be formed by avoiding abnormalities in the dot size on an image forming body and preventing peeling away of dots during removal of solvent, in an image forming method which causes ink to aggregate by reacting a treatment liquid with the ink.

In order to attain the aforementioned object, the present invention is directed to an image forming method of forming an image on an image forming body according to image data, the image is being formed by using an ink liquid containing a coloring material, the image forming method comprising the steps of: applying a first treatment liquid onto the image forming body, the first treatment liquid having a first pH that is lower than an aggregation pH of the ink liquid; after the step of applying the first treatment liquid, depositing droplets of the ink liquid onto the image forming body on which the first treatment liquid has been applied, the droplets of the ink liquid being deposited according to the image data; after the step of depositing the droplets of the ink liquid, applying a second treatment liquid onto the image forming body on which the droplets of the ink liquid have been deposited, the second treatment liquid having a second pH that is lower than the aggregation pH of the ink liquid and lower than the first pH of the first treatment liquid; and after the step of applying the second treatment liquid, removing solvent derived from the ink liquid on the image forming body.

In this aspect of the present invention, when ink droplets are deposited onto the image forming body onto which the first treatment liquid has been deposited, an aggregating reaction starts but the progress of the aggregating reaction (speed of aggregation) is slow, and the ink liquid can spread on the image forming body. Consequently, it is possible to obtain a prescribed contact surface area and a prescribed adhesive force between the aggregate (dots) formed by the aggregating reaction and the image forming body.

Moreover, since the second treatment liquid having a faster speed of aggregation than then first treatment liquid is deposited after the deposition of ink droplets, thereby causing the aggregating reaction of the ink droplets to progress at a very fast rate (causing the ink to aggregate instantaneously), then the aggregation of the ink will have completed before the solvent on the image forming body is removed after the deposition of the second treatment liquid, and therefore the peeling away of the aggregate (dots) from the image forming body during solvent removal is prevented.

As the ink liquid, it is suitable to use a pigment-based ink composed by dispersing pigment micro-particles forming a coloring material, in a solvent. Furthermore, it is also possible for the ink liquid to contain dispersed particles, such as polymer micro-particles or resin micro-particles, in addition to the pigment micro-particles. Moreover, it is also possible to use a dye-based ink composed by dissolving a dye-based coloring material in a solvent.

A desirable mode is one where the pH value of the ink liquid is not lower than 6.0 and lower than 13.0. Furthermore, a desirable mode is one where the aggregation pH of the ink liquid is not lower than 6.0 and not higher than 8.0.

Preferably, the first pH of the first treatment liquid is not lower than 5.0 and lower than 7.0; and the second pH of the second treatment liquid is not lower than 3.0 and lower than 5.0.

Preferably, the second treatment liquid contains a polyvalent cationic reactive group.

In this aspect of the present invention, even if using an ink containing dispersed particles which do not display an aggregating action in the presence of monovalent cations, it is still possible to obtain reliable aggregation of the ink liquid by deposition of the second treatment liquid, and peeling away of the aggregated material from the image forming body during the removal of the solvent on the image forming body after depositing the second treatment liquid can be prevented reliably.

Preferably, the ink liquid contains first particles and second particles dispersed therein, the first particles in the ink liquid aggregating when the ink liquid is in contact with the first treatment liquid, the second particles in the ink liquid aggregating when the ink liquid is in contact with the second treatment liquid.

In this aspect of the present invention, the first dispersed particles display an aggregating action due to reaction with the first treatment liquid, and on the other hand, the second dispersed particles do not display an aggregating action even if the ink liquid is in contact with the first treatment liquid. Therefore, the aggregating reaction of the ink liquid proceeds gradually due to the first treatment liquid, and hence the ink liquid can spread to a prescribed size on the image forming body. Furthermore, when the second treatment liquid is deposited, then the second dispersed particles display an aggregating reaction, and the aggregating reaction of the ink liquid proceeds very rapidly. Therefore, the ink aggregate is prevented from peeling away from the image forming body during the removal of the solvent on the image forming body which is carried out after the deposition of the second treatment liquid.

Preferably, the above-described image forming method further includes the step of transferring the image on the image forming body onto a recording medium, after the step of removing the solvent.

A desirable mode is one where the transfer step includes a heating step of heating the image forming body and the recording medium in such a manner that the temperature of the image forming body and the recording medium reaches the softening temperature (glass transition temperature) of the micro-particles which are contained in at least one of the first treatment liquid, the ink liquid and the second treatment liquid.

A desirable mode is one which includes, after the transfer step, a cooling step of cooling the image forming body and the recording medium, a separating step of separating the recording medium from the image forming body, a cleaning step of cleaning the image forming body after the separating step, and a fixing step of heating the recording medium in order to fix the image onto the recording medium which has been separated from the image forming body.

In order to attain the aforementioned object, the present invention is also directed to an inkjet recording apparatus which forms an image on an image forming body according to image data, the image is being formed by using an ink liquid containing a coloring material, the inkjet recording apparatus comprising: a first treatment liquid application device which applies a first treatment liquid onto the image forming body, the first treatment liquid having a first pH that is lower than an aggregation pH of the ink liquid; an inkjet head which deposits droplets of the ink liquid onto the image forming body on which the first treatment liquid has been applied by the first treatment liquid application device, the droplets of the ink liquid being deposited according to the image data; a second treatment liquid application device which applies a second treatment liquid onto the image forming body on which the droplets of the ink liquid have been deposited by the inkjet head, the second treatment liquid having a second pH that is lower than the aggregation pH of the ink liquid and lower than the first pH of the first treatment liquid; and a solvent removal device which removes solvent derived from the ink liquid on the image forming body on which the second treatment liquid has been applied by the second treatment liquid application device.

The solvent removal device may include a contact type of absorbing medium which contacts with the image forming body to suction and remove the solvent component on the image forming body, or it may include a non-contact type of member which removes the solvent component on the image forming body without making contact with the image forming body.

Preferably, the first pH of the first treatment liquid applied by the first treatment liquid application device is not lower than 5.0 and lower than 7.0; and the second pH of the second treatment liquid applied by the second treatment liquid application device is not lower than 3.0 and lower than 5.0.

Preferably, the above-described inkjet recording apparatus further includes a transfer device which transfers the image on the image forming body onto a recording medium, after the solvent on the image forming body has been removed by the solvent removal device.

In the transfer type of the inkjet recording apparatus which includes the transfer device, the primary image which is formed on the image forming body is a mirror image of the image that is to be formed on the recording medium.

A desirable mode is one which comprises a heating device which heats the image forming body and the recording medium in such a manner that the temperature of the image forming body and the recording medium reaches the softening temperature (the glass softening temperature) of the micro particles contained in the underlying liquid (undercoating liquid) during transfer by the transfer device.

Furthermore, a desirable mode is one which comprises a preheating device which preheats the image forming body after removing the solvent on the image forming body by means of the solvent removal device and before transfer by the transfer device. A desirable mode is one where the preheating device heats the image forming body and the recording medium to a temperature which is lower than the softening temperature of the micro-particles.

Furthermore, a desirable mode is one which comprises a cooling device which cools the image forming body and the recording medium after transfer, a separating device which separates the recording medium from the image forming body, a cleaning device which cleans the image forming body after separating the recording medium from the image forming body, and a fixing device which heats the recording medium in order to fix the image onto the recording medium that has been separated from the image forming body.

According to the present invention, when ink droplets are deposited onto an image forming body onto which a first treatment liquid has been deposited, an aggregating reaction starts but the progress of the aggregating reaction (speed of aggregation) is slow, and the ink liquid is able to spread on the image forming body. Consequently, it is possible to obtain a prescribed contact surface area and a prescribed adhesive force between the aggregate (dots) formed by the aggregating reaction and the image forming body.

Moreover, since a second treatment liquid having a faster speed of aggregation than that of the first treatment liquid is deposited after the deposition of ink droplets, thereby causing the aggregating reaction of the ink droplets to progress at a very fast rate (causing the ink to aggregate instantaneously), then the aggregation of the ink will have completed before the solvent on the image forming body is removed after the deposition of the second treatment liquid, and therefore the peeling away of the aggregate (dots) from the image forming body during solvent removal is prevented.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIGS. 1A to 1H are illustrative diagrams showing an image forming method according to an embodiment of the present invention;

FIG. 2 is a diagram showing the aggregation pH of ink;

FIG. 3 is a diagram showing the evaluation results of experiment 1 and experiment 2;

FIG. 4 is a diagram showing the evaluation results of experiment 2;

FIG. 5 is a diagram showing the evaluation results of experiment 3;

FIGS. 6A to 6H are diagrams showing an application example of an image forming method according to the present embodiment;

FIG. 7 is a general schematic drawing of an inkjet recording apparatus according to an embodiment of the present invention;

FIG. 8 is a principal plan diagram of the peripheral area of a print unit in the inkjet recording apparatus illustrated in FIG. 7;

FIGS. 9A to 9C are plan view perspective diagrams showing examples of the composition of the head of the inkjet recording apparatus shown in FIG. 7;

FIG. 10 is a cross-sectional diagram along line 10-10 in FIGS. 9A and 9B;

FIG. 11 is a general schematic drawing showing the composition of an ink supply system of the inkjet recording apparatus shown in FIG. 7;

FIG. 12 is a general schematic drawing showing the composition of a control system of the inkjet recording apparatus shown in FIG. 7;

FIG. 13 is a general schematic drawing of an inkjet recording apparatus according to a further embodiment of the present invention; and

FIGS. 14A to 14F are illustrative diagrams showing an image forming method according to the related art.

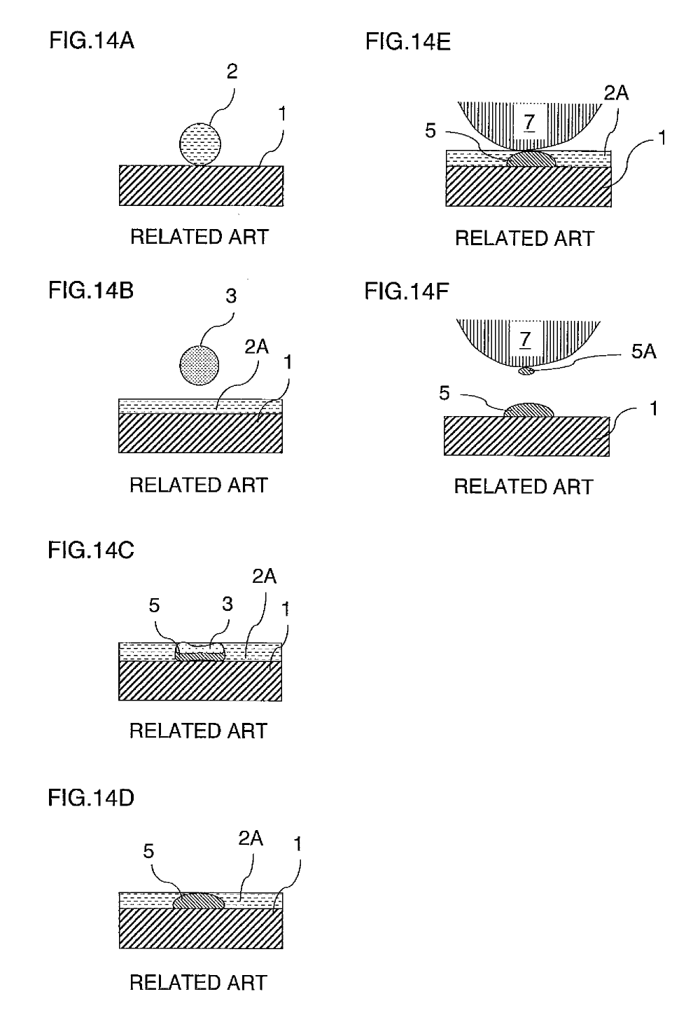

### DETAILED DESCRIPTION OF THE PREFERRED EMBODIMENTS

### Description of Image Formation Method

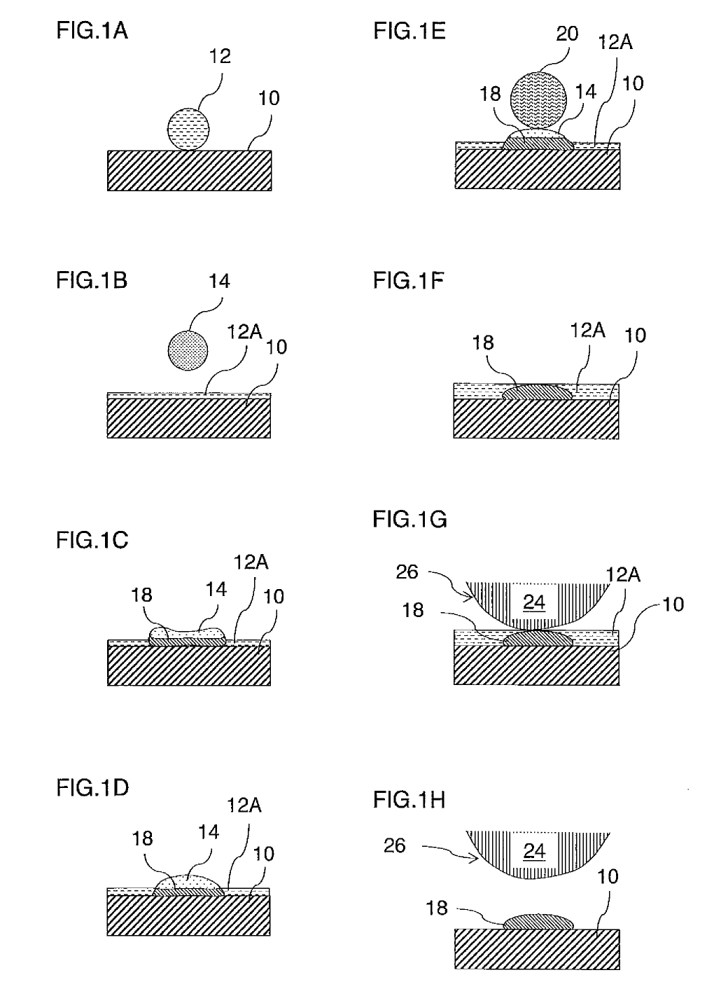

Firstly, an image forming method according to an embodiment of the present invention will be described with reference to FIGS. 1A to 1H. FIGS. 1A to 1H show schematic view of the respective steps of an image forming method according to an embodiment of the present invention.

The image forming method shown in FIGS. 1A to 1H comprises: a first treatment liquid deposition step of depositing a first treatment liquid 12 onto a prescribed region of the recording medium 10 (image forming body), the first treatment liquid 12 containing a component which causes the ink to aggregate by reacting with the ink (FIG. 1A); an ink droplet deposition step of depositing ink droplets 14 in accordance with image data onto the first treatment liquid 12 which has been deposited on the recording medium 10 (onto the first treatment liquid film 12A) (FIG. 1B); a first aggregating step in which the ink droplets 14 deposited onto the first treatment liquid film 12A spread to a prescribed size on the recording medium 10, and in the mixed liquid of the first treatment liquid 12 and the ink droplets 14, a portion of the ink droplets 14 (the dispersed particles contained in the ink droplets 14) aggregates and forms an aggregate 18 (FIGS. 1C and 1D); a second treatment liquid deposition step of depositing a second treatment liquid 20 having a faster speed of aggregating the ink droplets 14 than the first treatment liquid 12, onto unreacted ink droplets 14 which have not yet reacted on the recording medium 10 (FIG. 1E); a second aggregating step of separating the aggregate (dot) 18 and the solvent component by means of an aggregating reaction of the ink droplets 14 due to reaction of the second treatment liquid 20 and the unreacted ink droplets 14 (FIG. 1F); and a solvent removal step of removing the solvent component on the recording medium 10 by using a solvent removal member (absorbing roller 24) (FIGS. 1G and 1H).

The first treatment liquid 12 which is used in the image forming method according to the present embodiment, has a slower aggregation speed than the aggregation speed of the second treatment liquid, and hence there is the relationship: (aggregation speed of first treatment liquid)<(aggregation speed of second treatment liquid). If the aggregating speed is fast (high), then it takes a relatively short time for all of the coloring material (dispersed particles) contained in the ink droplets to be aggregated, whereas if the aggregating speed is slow (low), then it takes a relatively long time for all of the coloring material (dispersed particles) contained in the ink droplets to be aggregated.

Consequently, when an ink droplet 14 is deposited onto the first treatment liquid 12 and the first treatment liquid 12 mixes with the ink droplet 14, then an aggregating reaction occurs in the ink droplet 14 and the aggregate 18 (FIG. 1C) is produced; however, since the aggregating reaction does not complete instantaneously in the whole of the ink droplet 14 but rather the aggregating reaction of the ink droplet 14 progresses gradually, then the ink droplet 14 spreads to reach a prescribed size on the recording medium 10 while the aggregate 18 is being generated (see FIGS. 1C and 1D).

Furthermore, a portion of the ink droplet 14 is aggregated in the state of FIG. 1D (in other words, the ink droplet 14 is aggregated to some extent). Hence, even if another ink droplet is deposited in a continuous fashion onto an adjacent line pattern in such a manner that the ink liquid droplets which have been deposited onto mutually adjacent depositing positions make contact with each other, then these ink droplets do not combine together (depositing interference does not occur), and desired dots are formed by the respective ink droplets.

The term “spread to reach a prescribed size” means that the diameter d₁ of the ink droplet in flight and the diameter d₂ of the ink droplet after spreading satisfies a relationship of d₂≧d₁×1.5. In this case, it is assumed that the ejected ink droplet 14 (an ink droplet in flight from ejection until deposition) has a spherical shape, d₁ is determined as a diameter (ideal value) calculated from the ink droplet ejection volume, and d₂ corresponds to the dot diameter. Below, the value d₁ described above means the diameter of the ink droplet, or the diameter of the ink droplet in flight (the ink droplet upon ejection).

Supposing that an ink droplet 14 which does not aggregate is deposited onto the first treatment liquid film 12A under conditions where the ejection volume of the ink droplet is not smaller than 2 pl and not larger than 10 pl, the viscosity is not lower than 5 (Pa·s) and not higher than 30 (Pa·s), and the surface tension is not lower than 20 (mN/m) and not higher than 40 (mN/m), then the time period t from the deposition of the ink (the time point at which the ink droplet 14 makes contact with the first treatment liquid film 12A) until the ink reaches the maximum spreading rate (until the ink spreads at maximum) is between 5 μsec and 10 μsec. After the ink droplet 14 has reached the maximum spreading rate, it stabilizes at a dot diameter which is determined by the wetting properties of the ink droplet 14 and the recording medium 10. In order to ensure dot spreading, it is desirable that the ink should aggregate at a timing after reaching the maximum spreading rate. If the aggregating time is shorter than the time period t (if the ink droplet aggregates before reaching maximum spreading), then the aggregate 18 forms without having spread, a sufficient spreading (contact) surface area cannot be guaranteed on the recording medium 10, and a phenomenon is observed whereby the aggregate 18 moves within the first treatment liquid film 12A due to the insufficient adherence of the aggregate 18 onto the recording medium 10. There is the following tendency: the smaller the volume of the ink droplet 14 or the lower the ink viscosity, the shorter the time period t until reaching maximum spreading is.

As shown in FIG. 1C, since an aggregating reaction occurs in the portion of contact between the first treatment liquid film 12A and the ink droplet 14 immediately after deposition of the ink droplet 14, then the aggregate of very small size which is dispersed in the mixed liquid collects together with the passage of time to form aggregate of large size, which adheres to the recording medium 10 inside the mixed liquid.

If droplets of the second treatment liquid 20 are deposited onto the mixed liquid (unreacted ink droplets 14), in a state where the droplets 14 of ink (aggregate 18) have spread to a prescribed size, and where a portion (unreacted ink droplets 14) of the ink droplets 14 remains in an unreacted state (see FIG. 1E), then the unreacted ink droplets 14 (the dispersed particles in the mixed liquid) aggregate instantaneously, and as shown in FIG. 1F, separate into an aggregate 18 and a solvent component 22. Since the aggregating reaction is completed after the ink droplets 14 have spread sufficiently, then a sufficient contact surface area is obtained between the aggregate 18 and the recording medium 10, and a satisfactory adhesive force is ensured between the recording medium 10 and the aggregate 18.

In the present embodiment, the aggregating speed of the second treatment liquid 20 is faster than the aggregating speed of the first treatment liquid 12, and the unreacted portion which has not been aggregated completely by the first treatment liquid 12 is caused to undergo an aggregating reaction by the second treatment liquid 20, and hence the reaction is completed fully. For example, when an ink droplet 14 of 2 pl and a second treatment liquid 20 of 5 pl mix together, the ink droplet 14 aggregates completely in 1 sec, and it separates into an aggregate 18 and a solvent component (see FIG. 1F). Taking account of the system composition, the interval (distance) from the printing position until solvent removal is 500 mm or above, and considering that the conveyance speed is equivalent to 500 mm/s, then the time can be estimated to be 1 sec.

When the ink aggregate 18 has formed on the recording medium 10, the unwanted solvent present on the recording medium 10 is removed (see FIG. 1G). In the solvent removal step shown in FIG. 1G, a solvent removal process is performed using a absorbing roller 24. In this case, the absorbing roller 24 includes an absorbing body 26, such as a porous member, arranged on the surface of the absorbing roller 24. In the solvent removal process shown in FIG. 1G, the solvent on the recording medium 10 is removed by bringing the absorbing body 26 into contact with the solvent on the recording medium 10. FIG. 1H shows a state where solvent has been removed from the recording medium 10.

As shown in FIG. 1G, since the aggregate (dot) 18 is fixed on the recording medium 10 in a state where it has spread sufficiently, then an adequate adhesive force is obtained between the recording medium 10 and the aggregate 18. Consequently, in the solvent removal step, even if the absorbing roller 24 makes contact with the aggregate 18, then there is an extremely low probability of the aggregate 18 peeling away from the recording medium 10 and becoming attached to the absorbing roller 24.

It is also possible to adopt a solvent removal member which comprises a plurality of suction apertures in the surface thereof instead of the absorbing roller 24, and which suctions and removes the solvent on the recording medium 10 via these suction apertures. In place of a contact removal method performed in use of the absorbing roller 24, a method of drying a solvent on the recoding medium in use of a heater may be employed.

In the image forming method shown in the present embodiment, when the first treatment liquid 12 reacts with the ink droplets 14, then an aggregating reaction of the ink droplets 14 advances gradually on the recording medium 10, and therefore it is possible for the ink droplets 14 to spread to a prescribed size on the recording medium 10. Consequently, sufficient adhesive force (contact surface area) is ensured between the aggregate 18 generated by the aggregation of the ink droplets 14, and the recording medium 10, and hence abnormality in the dot size is avoided, and furthermore, the aggregate 18 is prevented from peeling away from the recording medium 10 due to the absorbing roller 24 making contact with the aggregate 18 on the recording medium 10 during removal of solvent.

Moreover, since the aggregating reaction proceeds gradually in the ink droplets 14 which have been deposited onto the recording medium 10, then even if ink droplets which are to form mutually adjacent dots are ejected in a continuous fashion and make contact with each other on the recording medium 10, combination of the respective ink droplets does not occur and dots having a prescribed size and shape can be formed.

In the present embodiment, a mode is described in which a pigment-based ink containing pigment micro-particles dispersed in a solvent is used, but it is also possible to employ a dye-based ink in which dye-type coloring material is dissolved in a solvent.

### Description of Evaluation Experiment

Next, an evaluation experiment which was used to corroborate the effectiveness (action and beneficial effects) of the present invention will be described. In this evaluation experiment, isolated dots were formed at a recording density (dot density) of 300×300 dpi on a recording medium, the image forming characteristics in this solid image before solvent removal were evaluated, and the presence or absence of adherence of the coloring material to the solvent removal member (absorbing roller 24 in FIGS. 1G and 1H) after solvent removal was evaluated.

A Geljet head (made by Ricoh) was used as the head for ejecting droplets of the first treatment liquid, second treatment liquid and ink. The droplet ejection conditions of the first treatment liquid and the second treatment liquid were: ejection volume per ejection (per droplet) of 5 pl, dot density of 1200×1200 dpi; and the ink droplet ejection conditions were: ejection volume per ejection (per droplet) of 2 pl and dot density of 300×300 dpi.

In evaluating the image forming characteristics, droplets of the second treatment liquid (reference numeral 20 in FIG. 1E) were deposited, and the diameter d₂ of the dots (reference numeral 18 in FIG. 1F) deposited on the recording medium after 60 seconds had elapsed was measured. The diameter d₂ of the dots immediately after depositing droplets of the second treatment liquid was kept measured for a while, but no change in the diameter d₂ of the dots was observed after 5 seconds had elapsed from the deposition of droplets of the second treatment liquid.

In the evaluation of the image forming characteristics, the dot spreading rate was determined by finding the ratio d₂/d₁ between the diameter d₁ of the ink droplet upon ejection and the diameter d₂ of the dot which is fixed on the recording medium, and if the dot spreading rate is equal to or greater than 1.5, then it was considered that an image having a prescribed dot size had been formed (“good” verdict).

For example, if the ejection volume of the ink droplet is 2 pl, then the diameter d₁ of the ink upon ejection is 15.6 μm. If the dot density is 1200×1200 dpi, then the dot-to-dot pitch is a minimum of approximately 21 μm, and if the dot spreading rate is equal to greater than 1.5, then the dot diameter d₂ is 23.4 μm, and therefore it can be seen that a desirable solid image can be formed in which the mutually adjacent dots are connected together (make contact with each other). On the other hand, if the dot spreading rate is less than 1.5, then gaps occur between the mutually adjacent dots which are originally intended to make contact with each other, and this can be recognized as an image defect.

Furthermore, in the evaluation of the adherence of coloring material during solvent removal (the peeling away of dots after solvent removal), the dots on the recording medium after solvent removal were observed with a microscope, the number of remaining dots was counted, and the dot survival rate was determined accordingly. The dot survival rate in the evaluation experiment is indicated as the ratio of the number of dots remaining on the recording medium to the total number of dots (i.e., 10 dots), and if the dot survival rate was equal to or greater than 90% (if the dots remaining on the recording medium was 9 or 10 dots when the total number of dots is 10), a verdict of “good” was given, whereas if this rate was less than 90% (if the dots remaining on the recording medium was equal to or less than 8 dots when the total number of dots is 10), then a verdict of “poor” was given.

The composition and physical properties of the first treatment liquid and the second treatment liquid used in this evaluation experiment are shown below.

(Physical Properties of First Treatment Liquid)

(1) pH value: not lower than 5 and lower than 7 (weakly acidic, causes gradual aggregation of the ink droplets)

(2) Contains monovalent cationic material (carboxylic acid)

(3) Surface tension: not lower than 20 mN/m and not higher than 40 mN/m

(4) Viscosity: not lower than 5 Pa·s and not higher than 30 Pa·s

(Second Treatment Liquid)

(1) pH value: not lower than 3 and lower than 5 (strongly acidic, causes very rapid aggregation of the ink droplets)

(2) Contains monovalent cationic material (carboxylic acid) or polyvalent metal ion (Mg²⁺, Ca²⁺).

(3) Surface tension: not lower than 20 mN/m and not higher than 40 mN/m

(4) Viscosity: not lower than 5 Pa·s and not higher than 30 Pa·s

Furthermore, the composition and physical properties of the ink were as follows.

### (Composition and Physical Properties of Ink)

Ink 1: Pigment-based ink

Ink 2: Pigment-based ink+latex (Jurymer ET410, made by Nihon Junyaku Co., Ltd.)

Ink 3: Pigment-based ink+latex (Joncryl 537, made by Johnson Polymers)

Common properties of inks 1 to 3 are as follows.

(1) pH value: not lower than 7 and lower than 13

(2) Surface tension (desirable condition): not lower than 20 mN/m and not higher than 40 mN/m

(3) Viscosity (desirable condition): not lower than 5 Pa·s and not higher than 30 Pa·s

(4) Amount of coloring material (as estimated from viscosity): not less than 4 wt % and not greater than 20 wt %.

The aggregation pH of the inks 1 to 3 was found in the following way. In this case, the “aggregation pH” of an ink is a pH at which the ink starts to aggregate.

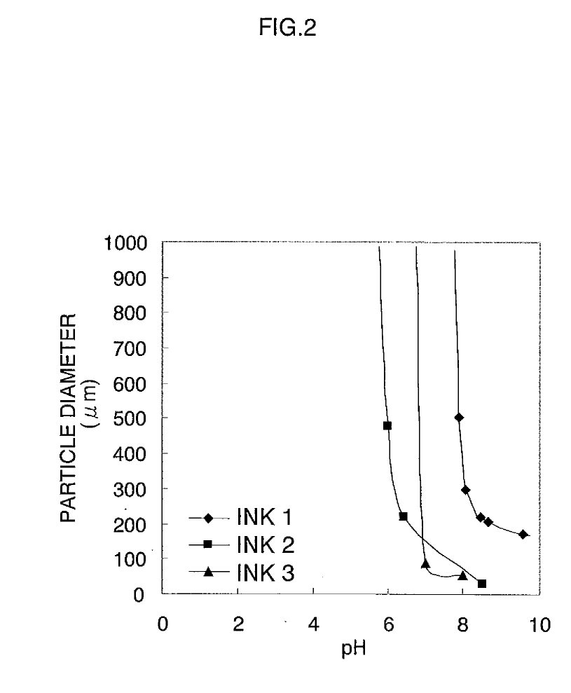

The pigment-based inks 1 to 3 were diluted 1000 times with deionized water, mixed at a ratio of 1 to 1 with an aqueous solution of pigment/pyrrolidone carboxylic acid, and the density of an aqueous acid solution mixed with same was varied between 0 to 10% so as to alter the pH value successively, the diameter of the aggregate particles being measured by means of a dynamic light scattering particle size analyzer (LB550, made by Horiba). FIG. 2 shows the relationship between the pH value of the inks 1 to 3 and the particle diameter of the coloring material particles.

Since the size of the coloring material particles dispersed in the ink becomes greater due to the aggregating reaction, then the pH value at which the particle size changes suddenly is defined as the aggregation pH of each ink. As shown in FIG. 2, the aggregation pH of the ink 1 is 8.0, the aggregation pH of the ink 2 is 6.5 and the aggregation pH of the ink 3 is 7.0.

Furthermore, the pigment used in this evaluation experiment was a cyan pigment. The cyan pigment particles were adjusted to a suitable particle size by dispersion in a beads mill.

Ink 1 was a liquid containing pigment particles dispersed in a dispersion medium, in such a manner that the pigment content was 4 wt % with respect to the total volume of ink; and ink 2 was a liquid containing latex (Jurymer ET410, made by Nihon Junyaku, Co., Ltd.) of 8 wt % and pigment particles of 4 wt %. Moreover, the ink 3 was a liquid containing latex (Joncryl 537, made by Johnson Polymers) of 8 wt % and pigment particles of 4 wt %.

### Experiment 1: pH Value of First Treatment Liquid

Next, the experiment 1 will be described. In experiment 1, the image forming characteristics and the adherence of the coloring material during solvent removal were evaluated by altering the pH value of the first treatment liquid. The treatment liquids having various pH values were manufactured by the following method.

5 g of lithium hydroxide was added a little at a time to 45 g of water, while agitating, to manufacture a 10% aqueous solution of LiOH.H2O, and PCA (organic carboxylic acid), glycerine, DEG (diethylene glycol), LiOH.H2O, Olefin (E1010), water were combined at the mixture ratio shown below and agitated, to make a treatment liquid having a pH value of 3.6.

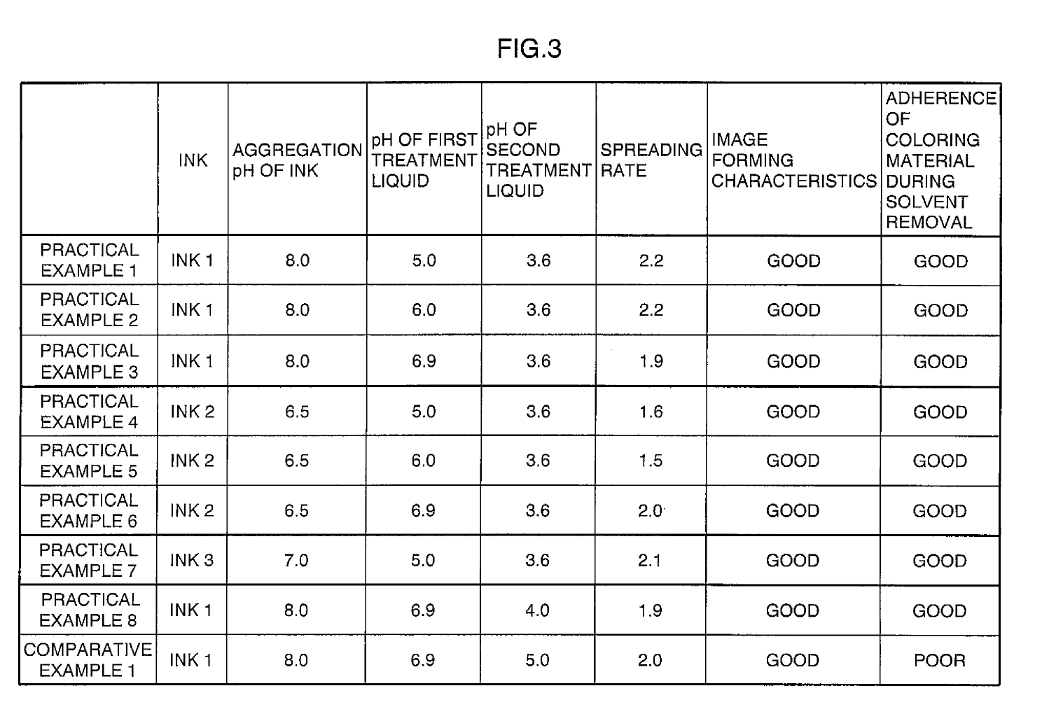

Furthermore, treatment liquids having pH values of 5.0, 6.5 and 6.9 were prepared by altering the titrated amount of 10% aqueous solution of LiOH.H2O. A treatment liquid having a pH value of 3.6 manufactured by the method described above was taken as the second treatment liquid, and treatment liquids having pH values of 5.0, 6.5 and 6.9 were taken as the first treatment liquid. FIG. 3 is a diagram showing the evaluation results of the experiment 1.

As shown by the practical examples 1 to 3 in FIG. 3, if an ink 1 (having an aggregation pH of 8.0) was used, then with a pH value of 5.0, 6.0 and 6.9 of the first treatment liquid, in all cases, the dot spreading rate was equal to or greater than 1.5 and hence the evaluation verdict for the image forming characteristics was “good”. Moreover, the evaluation of the adherence of coloring material during solvent removal was “good” in each case.

Furthermore, as shown by the experiment examples 4 to 6 in FIG. 3, even if an ink 2 (having an aggregation pH of 6.5) was used, then with a pH value of 5.0, 6.0 and 6.9 of the first treatment liquid, in all cases, the dot spreading rate was equal to or greater than 1.5 and hence the evaluation verdict for the image forming characteristics was “good”, and the evaluation verdict for the adherence of coloring material during solvent removal was also “good”.

At a pH value to the lower side of the aggregation start pH, the ink aggregating reaction proceeds suddenly, and at a pH value to the higher side of the aggregation start pH, then while the salt also has an effect, the aggregating reaction proceeds at a slower rate.

Moreover, as shown by the example 7 in FIG. 3, if an ink 3 (having an aggregation pH of 7.0) was used, then with a pH value of 5.0 of the first treatment liquid, the dot spreading rate was 1.9 and hence the evaluation verdict for the image forming characteristics was “good”. Furthermore, the evaluation verdict of the adherence of coloring material during solvent removal was “good”.

As described above, from the evaluation results of the experiment 1 shown in FIG. 3, it was corroborated that a favorable image is formed in which a dot spreading rate equal to or greater than 1.5 is ensured, when the pH value of the first treatment liquid is in the range of equal to or higher than 5.0 and lower than 7.0 (equal to or lower than 6.9). In the present evaluation experiment, an acid-base aggregating ink set is used, and hence the treatment liquid is acidic and the ink is a base. Therefore, the pH value of the treatment liquid is lower than 7.0.

### Experiment 2: pH Value of Second Treatment Liquid

Next, the experiment 2 will be described. In the experiment 2, the image forming characteristics were evaluated and the adherence of the coloring material during solvent removal were evaluated, by altering the pH value of the second treatment liquid in the examples 1 to 7 of Experiment 1, from 3.6 to 4.0 or 5.0.

The example 8 in FIG. 3 shows a case where the pH value of the second treatment liquid in the example 3 shown in FIG. 3 was changed to 4.0. In example 8, the dot spreading rate was 1.9, the evaluation verdict of the image forming characteristics was “good”, and the evaluation verdict of the adherence of the coloring material during solvent removal was “good”. On the other hand, the comparative example 1 in FIG. 3 shows a case where the pH value of the second treatment liquid in the example 3 shown in FIG. 3 was changed to 5.0. In the comparative example 1, since the dot spreading rate was 2.0, then the evaluation verdict for the image forming characteristics was “good”, but the evaluation verdict for the adherence of the coloring material during solvent removal was “poor” (the number of remaining dots was equal to or lower than 8 dots when the total number of dots is 10). In other words, from the viewpoint of the adherence of the coloring material during solvent removal, it is desirable that the pH value of the second treatment liquid should be lower than 5.0.

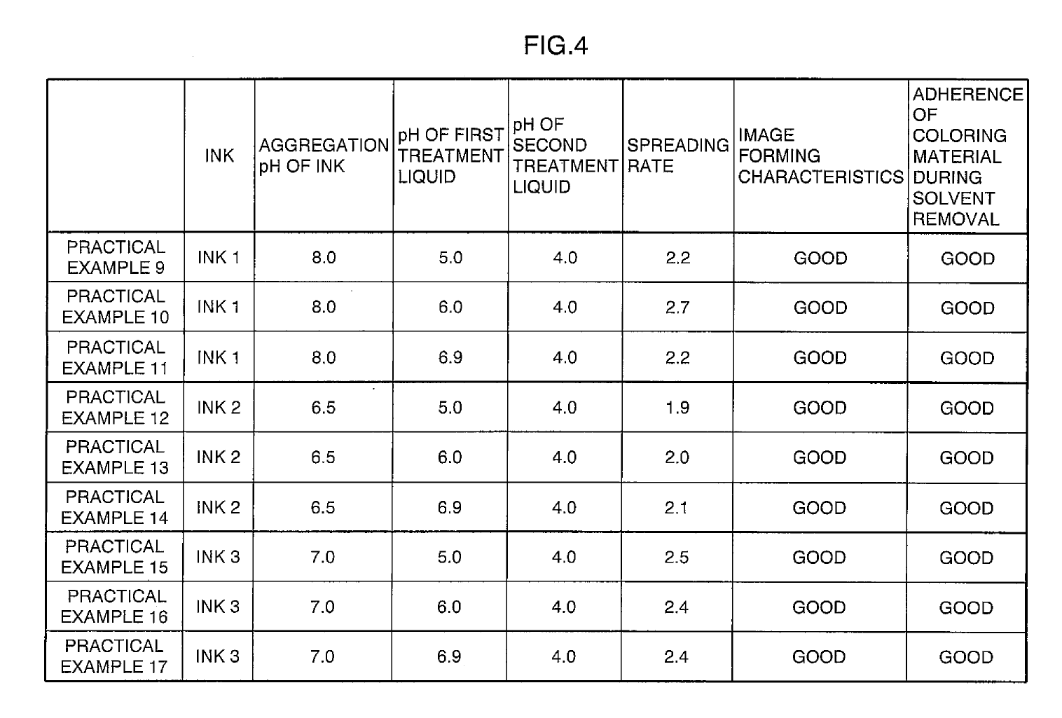

The examples 9 to 15 shown in FIG. 4 are the evaluation results when the pH value of the second treatment liquid in the examples 1 to 7 shown in FIG. 3 was 4.0, and the examples 16 and 17 show the evaluation results when the pH value of the first treatment liquid was 6.0 and 6.9, using the ink 3.

Examples 9 to 17 shown in FIG. 4 each have a dot spreading rate of 1.5 or above and an evaluation verdict of “good” for the image forming characteristics. Furthermore, examples 9 to 17 also have a “good” verdict for the adherence of the coloring material during solvent removal. Consequently, a desirable pH value for the second treatment liquid is equal to or greater than 3.6 and lower than 5.0.

If phosphoric acid, or the like, is used for the second treatment liquid, then the pH value can be set to approximately 2.0. For example, if the pH value of the second treatment liquid is taken to be 2.0, then the evaluation verdict for the image forming characteristics and the evaluation verdict for the adherence of coloring material during solvent removal was “good” in both cases (the evaluation results are omitted from the drawing), but if the chemical resistance of the components of the apparatus is taken into account (since it is necessary to adopt a composition which ensures durability with respect to strongly acidic liquids in the second treatment liquid deposition device and the device which conveys the recording medium, and the like), then the pH value of the second treatment liquid is desirably set to be 3.0 or higher.

A desirable mode is one where the second treatment liquid includes polyvalent cations (e.g., polyvalent metal ions) such as Mg²⁺, Ca²⁺, or the like. The polyvalent cations have the function of causing aggregation of particles which are not liable to aggregate when reacted with monovalent cations, such as carboxylic acid, and they display especially beneficial effects in a case which uses an ink containing particles which are not liable to aggregate even when reacted with monovalent cations.

It is also possible to use calcium nitrate tetrahydrate, aluminum nitrate nonahydrate, aluminum sulfate, or the like, as the acid of the treatment liquid containing polyvalent cations, and in the present evaluation experiment, a mixture was prepared comprising 7.5 wt % of aluminum nitrate nonahydrate, 12.5 wt % glycerine, 10.0 wt % DEG, 1.5 wt % Olefin (E1010) and the remainder water, and the pH was then adjusted with great precision by dropwise addition of a 10% aqueous solution of lithium hydroxide.

The evaluation results are not shown here, but even when a second treatment liquid fabricated by the method shown was used, it was possible to obtain similar results to those described above.

### Experiment 3: Only Using a First Treatment Liquid

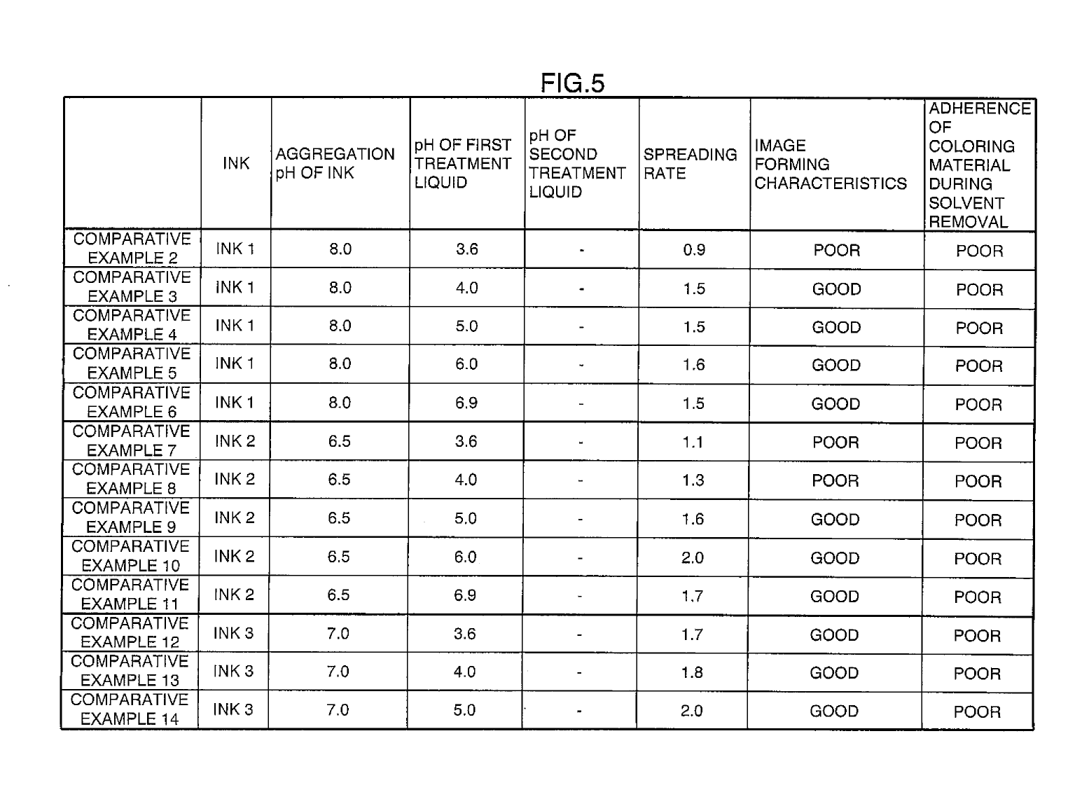

Next, the experiment 3 will be described. In experiment 3, the image forming characteristics and the adherence of coloring material are evaluated in a case where only the first treatment liquid is used. FIG. 5 shows the evaluation results of the experiment 3.

Each of the comparative examples 2 to 14 in FIG. 5 had an evaluation verdict of “poor” for the adherence of coloring material during solvent removal, and in the case where only the first treatment liquid was used and no second treatment liquid was used, the aggregating reaction of the ink does not complete within a prescribed time period (within 60 seconds in the present evaluation experiment), and therefore it is not possible to ensure a prescribed adhesive force between the recording medium and the dots and peeling away of the dots occurs during solvent removal, thus leading to deterioration in the image quality.

Furthermore, when ink 1 is used, if the pH value of the first treatment liquid is 3.6 (comparative example 2), then the dot spreading rate is 0.9 and an ink spreading rate of 1.5 or above cannot be obtained (evaluation verdict of “poor” for image forming characteristics). Similarly, when ink 2 is used, if the pH value of the first treatment liquid is 3.6 (comparative example 9) or 4.0 (comparative example 8), then the dot spreading rates are respectively 1.1 and 1.3, and an ink spreading rate of 1.5 or above cannot be obtained (evaluation verdict of “poor” for image forming characteristics).

In other words, from the viewpoint of image forming characteristics (dot spreading rate), the pH value of the first treatment liquid is desirably greater than 4.0, and even more desirably, 5.0 or higher.

To summarize the evaluation results of the experiments 1 to 3 described above, in image formation using an ink having an aggregation pH of 6.5, 7.0 or 8.0 (an ink pH value equal to or greater than 5.0 and lower than 13.0), if the pH value of the first treatment liquid is higher than 4.0 and lower than 7.0, then a dot spreading rate equal to or greater than 1.5 can be obtained. Desirably, the pH value of the first treatment liquid is equal to or greater than 5.0 and lower than 7.0, since this makes it possible to obtain a dot spreading rate of 1.5 or greater in a more reliable fashion.

Furthermore, it is desirable if the pH value of the second treatment liquid is lower than 5.0, since this prevents the peeling away of the dots during solvent removal, and it is desirable if the pH value of the second treatment liquid is equal to or lower than 4.0, since the aggregating reaction of the ink by the second treatment liquid is completed more quickly. On the other hand, from the viewpoint of the chemical resistance of the components of the apparatus, a desirable mode is one where the pH value of the second treatment liquid is equal to or greater than 3.0, and a more desirable mode is one where the pH value of the second treatment liquid is equal to or greater than 3.6.

In other words, a desirable pH value for the second treatment liquid is equal to or greater than 3.0 and lower than 5.0, and a more desirable pH value for the second treatment liquid is equal to or greater than 3.6 and equal to or lower than 4.0.

As desirable pigment particles contained in the ink, it is possible to cite a self-dispersing pigment. A self-dispersing pigment is a pigment which disperses and/or dissolves in a water-based solvent without the use of a dispersant. In the self-dispersing pigment, a plurality of hydrophilic functional groups and/or salts thereof (hereinafter, called “dispersion imparting groups”) may be bonded directly, or indirectly via an alkyl group, alkyl ether group or aryl group, to the surface of the pigment.

An ink which contains a self-dispersing pigment as a coloring material does not need to include a dispersant which is included in order to disperse a normal pigment, and there is virtually no foaming due to the reduction of defoaming property caused by the dispersant, and hence an ink having excellent ejection stability can be manufactured easily.

The dispersion imparting group which is bonded to the surface of the self-dispersing pigment may be —COOH, —CO, —OH, —SO₃H, —PO₃H₂ and quaternary ammonium, and salts of these. These are manufactured by subjecting a pigment starter material to a physical treatment or chemical treatment, so as to bond (graft) a dispersion imparting group or an active species having a dispersion imparting group to the surface of the pigment.

Vacuum plasma processing, or the like, is one example of the physical treatment. Furthermore, possible examples of a chemical treatment are: a wet oxidation method which oxidizes the pigment surface by means of an oxidizing agent in water, or a method for bonding p-aminobenzoic acid to the surface of the pigment, for instance.

In the experiments 1 to 3 described above, a pigment-based ink was used, but it is also possible to obtain similar results generally using a solvent-insoluble dispersion which contains polymer particles.

### Application Example

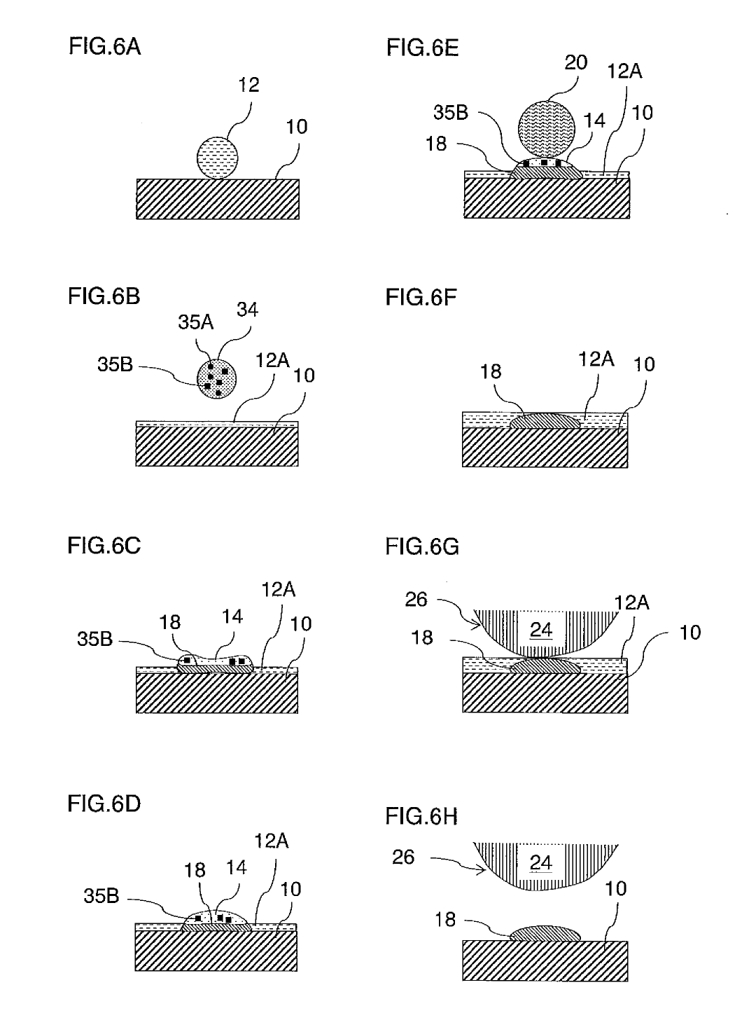

Next, an application example of the image forming method relating to the present invention will be described with reference to FIGS. 6A to 6H. In the present adaptation example, an ink is used which contains a component that produces an aggregating action upon reaction with a first treatment liquid and a component that produces an aggregation action upon reaction with a second treatment liquid.

In other words, the ink droplet 34 shown in FIG. 6B includes first dispersed particles 35A which have an aggregation pH corresponding to the pH value of the first treatment liquid, and second dispersed particles 35B which have an aggregation pH corresponding to the pH value of the second treatment liquid. When the ink droplet 34 is ejected (FIG. 6B) toward the recording medium 10 on which the first treatment liquid 12 has been deposited (FIG. 6A), an aggregate 18 is generated due to the occurrence of an aggregating action of the first dispersed particles 35A which have an aggregation pH corresponding to the pH value of the first treatment liquid 12 (FIG. 6C), and an ink spreading rate equal to or greater than 1.5 is ensured in the ink droplet 34, as well as preventing depositing interference (FIG. 6D).

Moreover, when the second treatment liquid 20 is deposited (FIG. 6E), an aggregating action of the second dispersed particles 35B occurs, and the whole of the ink droplet (all of the dispersed particles 35A and 35B inside the ink droplet) are caused to aggregate (FIG. 6F). Subsequently, even if solvent is removed by bringing an absorbing roller 24 into contact with the solvent on the recording medium 10 (FIG. 6G), then there is no adherence of coloring material to the absorbing body 26 on the surface of the absorbing roller 24, and the solvent on the recording medium is removed (FIG. 6H).

For example, an ink is used in which the pigment particles used in the ink 1 described above (having an aggregation pH of 8.0; first dispersed particles) and the pigment particles used in the ink 2 and latex (having an aggregation pH of 6.5; second dispersed particles) are dispersed in a solvent at a 1:1 ratio, and the pH value of the first treatment liquid was set to 6.9, while the pH value of the second treatment liquid was set to 5.0.

When the first treatment liquid and the ink mix together, an aggregating action occurs in the first dispersed particles which have an aggregation pH of 8.0, and approximately one half of the dispersed particles contained in the ink are aggregated. On the other hand, an aggregating action does not occur in the second dispersed particles which have an aggregation pH of 6.5, and these particles remain in a dispersed and unreacted state.

When the second treatment liquid is deposited, an aggregating action of the second dispersed particles which are in a dispersed state occurs, and all of the dispersed particles contained in the ink aggregate.

In the application example, the ink contains the first particles and the second particles dispersed therein, the first particles in the ink aggregating when the ink is in contact with the first treatment liquid, the second particles in the ink aggregating when the ink is in contact with the second treatment liquid. Hence, when ink droplets are deposited in a state where the first treatment liquid has been deposited on the recording medium, the ink droplets can spread to a prescribed size (a prescribed dot spreading rate is ensured), and furthermore a portion of the ink aggregates and thus depositing interference is prevented, since the aggregation reaction begins to exhibit only with the first dispersed particles. Moreover, when the second treatment liquid is deposited onto ink droplets in which the first dispersed particles have aggregated and the second dispersed particles are dispersed and have not aggregated, then an aggregating action of the second dispersed particles occurs and all of the dispersed particles contained in the ink aggregate, and therefore adherence of the coloring material to the solvent removal member during solvent removal is prevented.

The mixing ratio of the first dispersed particles and the second dispersed particles is not limited to 1:1 (weight ratio). For example, it is also possible to lower the content ratio of the first dispersed particles with respect to the second dispersed particles, provided that the first dispersed particles aggregate to a degree which prevents the occurrence of the depositing interference. A beneficial effect in preventing depositing interference can be obtained even when the mixing ratio of the first dispersed particles and the second dispersed particles is approximately 1:5.

Furthermore, if the first dispersed particles are latex for fixing (which has aggregating properties) and the second dispersed particles are pigment (which does not have aggregating properties), then in order to achieve satisfactory fixing properties, it is desirable to have a mixing ratio between the first dispersed particles and the second dispersed particles of 2:1 to 10:1 (weight ratio). The pigment density must be equal to or greater than 4 wt % in order to obtain suitable optical density in the image. In other words, if the concentration of the pigment which does not have aggregating properties is 4 wt %, then the fixing latex desirably has a content equal to or greater than 0.8 wt %, and more desirably, equal to or greater than 8 wt %.

### Image Fortune Apparatus

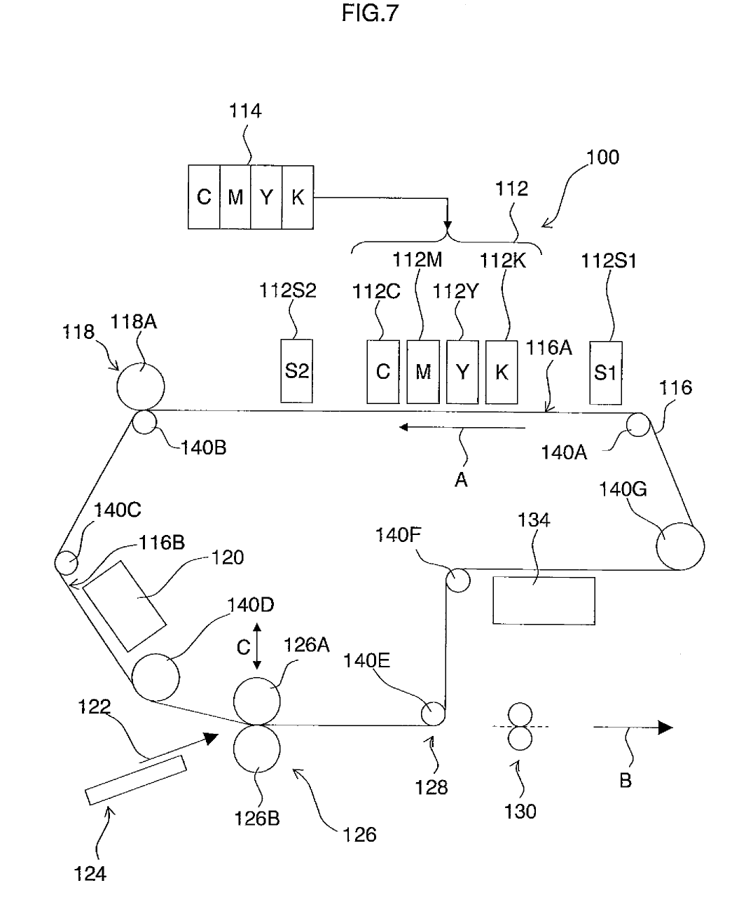

Next, an image forming apparatus (inkjet recording apparatus) which uses the image forming method according to the above-described embodiment of the present invention will be described. The inkjet recording apparatus 100 shown in FIG. 7 employs a transfer recording method.

The inkjet recording apparatus 100 shown in FIG. 7 comprises: a first treatment liquid head 112S1 which ejects droplets of a first treatment liquid on the basis of dot data corresponding to the image data, onto the image forming region (not illustrated) of the intermediate transfer medium 116, before ejecting droplets of ink from a print unit 112; a print unit 112, provided after the first treatment liquid head 112S, comprising a plurality of inkjet heads 112K, 112Y, 112M and 112C provided to correspond to inks containing coloring materials of respective colors of black (K), yellow (Y), magenta (M) and cyan (C); an ink storing and loading unit114 which stores inks to be supplied to the respective inkjet heads 112K, 112Y, 112M and 112C of the print unit 112; a second treatment liquid head 112S2, provided after the respective print unit 112 (to the downstream side thereof in terms of the direction of movement of the intermediate transfer medium), which ejects droplets of a second treatment liquid on the basis of dot data corresponding to the image data; a solvent removal unit 118 comprising an absorbing roller 118A which absorbs and removes solvent remaining on the image forming surface 116A of the intermediate transfer medium 116 on which a primary image has been formed; a heater 120 which heats a primary image formed on the intermediate transfer medium 116 from which the solvent has been removed, from the opposite surface 116B of intermediate transfer medium 116 with respect to the image forming surface 116A; a paper supply unit 124 which accommodates a recording medium 122 onto which the primary image formed on the intermediate transfer medium 116 is to be transferred and recorded, and which supplies the recording medium 122 to a transfer recording unit 126; a transfer recording unit 126, provided after the heater 120, which transfers and records the primary image formed on the intermediate transfer medium, to the recording medium 122, by pressing the intermediate transfer medium 116 and the recording medium 122 against each other in a state where the image recording surface (image recording region) of the recording medium 122 supplied from the paper supply unit 124 is in a state of contact with the image forming region of the intermediate transfer medium 116; a separation unit 128, provided after the transfer recording unit 126, which separates the recording medium 122 from the intermediate transfer medium 116; a fixing unit 130 which fixes the transferred and recorded image onto the recording medium, after it has been separated from the intermediate transfer medium; a paper output unit 132 which outputs the recording medium that has undergone a fixing process by the fixing unit 130, to the exterior of the apparatus; and a cleaning unit 134, provided after the separation unit 128, which cleans the image forming region of the intermediate transfer medium 116 after transfer recording.

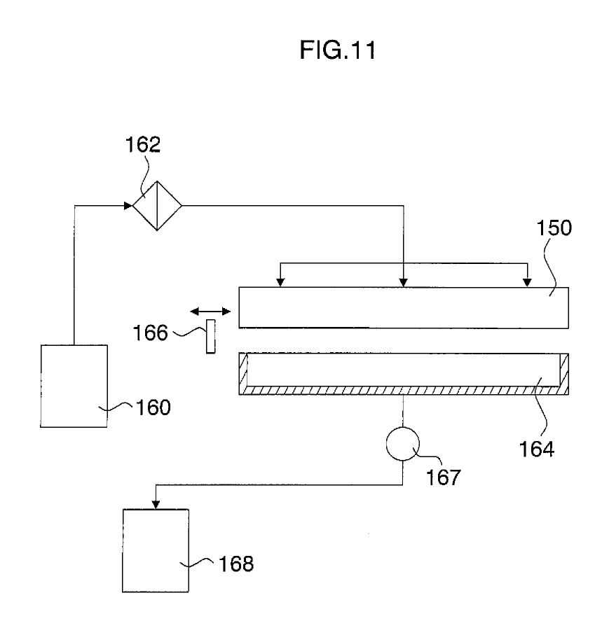

The ink storing and loading unit 114 has ink supply tanks for storing the inks of K, C, M and Y to be supplied to the heads (not shown in FIG. 7, but shown as reference numeral 160 in FIG. 11), and the supply tanks are connected to the heads by means of prescribed flow channels.

The ink storing and loading unit 114 has a warning device (for example, a display device or an alarm sound generator) for warning when the remaining amount of any ink is low, and has a mechanism for preventing loading errors among the colors.

The intermediate transfer medium 116 is an endless belt which is wound about a plurality of tensioning rollers 140A to 140Q and when at least one tensioning roller (drive roller) of the plurality of tensioning rollers 140A to 140G is turned, then the intermediate transfer medium 116 is moved in a prescribed direction in synchronism with the rotation of the drive roller. For example, if the tensioning roller 140A is taken as a drive roller and rotated in a counter-clockwise direction, then the intermediate transfer medium 116 moves from right to left in FIG. 7, in the print region which is directly below the print unit 112.

In the inkjet recording apparatus 100 according to the present example, the speed of conveyance of the intermediate transfer medium 116 is uniform through the series of image forming processes, and this speed is 10 mm/s.

Furthermore, the intermediate transfer medium 116 is made of resin, metal, rubber, or the like, and has non-permeable properties that prevent permeation of resin liquid or ink droplets, in at least the image forming region where the primary image is formed, of the surface which opposes the print unit 112 (image forming surface 112A). In other words, the aggregating treatment liquid which is deposited on the image forming region of the intermediate transfer medium 116 is held on the surface of the intermediate transfer medium 116 rather than permeating into the intermediate transfer medium 116. Furthermore, at least the image forming region of the intermediate transfer medium 116 is composed so as to have a horizontal surface (flat surface) which has a prescribed flatness.

It is also possible to adopt a medium which has a slow speed of permeation of the aggregating treatment liquid in the image forming region of the intermediate transfer medium 116 (for example, it is possible to use a medium having low permeability whereby the decrease in the amount (thickness) of aggregating treatment liquid from the deposition of the aggregating treatment liquid until its arrival at a position directly below the print unit 112 is equal to or less than 10%). In other words, for the intermediate transfer medium 116, it is possible to use a medium having very low permeability in which the decrease in the volume (thickness) of the aggregating treatment liquid from the deposition of the aggregating treatment liquid until its arrival at the printing region directly below the print unit 112 is equal to or less than 1%, or a medium having low permeability in which the aforementioned decrease in the aggregating treatment liquid is equal to or less than 10%.

FIG. 7 shows an endless belt as one mode of the intermediate transfer medium 116, but the intermediate transfer medium used in the present invention may also have a drum shape or a flat plat shape.

Desirable materials for use as the surface layer which includes the image forming surface of the intermediate transfer medium 116 are, for example, commonly known materials such as: a polyimide resin, a silicon resin, a polyurethane resin, a polyester resin, a polystyrene resin, a polyolefin resin, a polybutadiene resin, a polyamide resin, a polyvinyl chloride resin, a polyethylene resin, a fluorine resin, and the like.

The surface energy of the surface layer of the intermediate transfer medium 116 is desirably set to be equal to or greater than 10 mN/m and equal to or less than 40 mN/m. If the surface energy of the surface layer of the intermediate transfer medium 116 is equal to or greater than 40 mN/m, then the surface tension differential with respect to the recording medium 122 onto which the primary image is to be transferred and recorded disappears (or to becomes extremely low), and the transfer properties of the ink aggregate worsen. Moreover, if the surface energy of the surface layer of the intermediate transfer medium 116 is equal to or less than 10 mN/m, then if the wetting properties of the aggregating treatment liquid are taken into account, it is necessary to set the surface tension of the aggregating treatment liquid to be lower than the surface energy of the surface layer on the intermediate transfer medium 116, and since it is difficult to make the surface tension of the aggregating treatment liquid equal to or less than 10 mN/m, then the design freedom (range of selection) of the intermediate transfer medium 116 and the aggregating treatment liquid is restricted.

If the surface layer of the intermediate transfer body 116 has concavoconvex undulations having a surface roughness of Ra 0.3 μm, then this is desirable since it produces an effect in suppressing movement of the ink droplets and the ink aggregate.

Droplets of first treatment liquid are ejected by the first treatment liquid head 112S1 onto the intermediate transfer medium 116 which has completed a cleaning step by the cleaning unit 134 (first treatment liquid application step). The minimum droplet ejection volume of the first treatment liquid in the inkjet recording apparatus 100 shown in the present embodiment is 5 pl, the maximum output resolution is 1200×1200 dpi in both the main scanning direction (the direction perpendicular to the direction of movement of the intermediate transfer medium) and the sub-scanning direction (direction of movement of the intermediate transfer medium), and droplets of the first treatment liquid are ejected onto the whole surface of the image forming region of the intermediate transfer body 116.

The dots formed on the first treatment liquid may have the same size as the ink dots and may also have a greater size than the ink dots. Moreover, it is also possible to deposit a plurality of ink dots for one dot of the first treatment liquid.

Furthermore, the first treatment liquid may also be applied over the whole surface of the image forming region of the intermediate transfer body 116 by means of a cleaning roller or a spray system. In a mode where the first treatment liquid is applied by an application roller, it is desirable to use for the application roller a porous material of a material having surface undulations, for instance, it is possible to use a gravure roller, or the like.

When droplets of the first treatment liquid are ejected onto the intermediate transfer medium 116, droplets of color inks corresponding to the respective colors of KCMY are ejected, in accordance with image data (dot data), from the inkjet heads 112K, 112Y, 112M and 112C onto the printing region directly below the print unit 112 (printing step, ink droplet ejection step).

The minimum droplet ejection volume of the ink from the inkjet recording apparatus 100 shown in the present example is 2 pl, and the maximum output resolution is 300 dpi in both the main scanning direction (the direction perpendicular to the direction of movement of the intermediate transfer medium) and the sub-scanning direction (the direction of movement of the intermediate transfer medium).

When droplets are ejected from the inkjet heads 112K, 112Y, 112M and 112C, an aggregating reaction of the ink occurs on the intermediate transfer body 116, and an aggregate (reference numeral 18 in FIG. 1D) is formed. On the other hand, since the aggregating region produced by the first treatment liquid is a weak aggregating reaction, then the ink droplets are able to spread to a prescribed size.

Moreover, droplets of a second treatment liquid are ejected from the second treatment liquid head. The minimum droplet ejection volume of the second treatment liquid from the inkjet recording apparatus 100 shown in the present example is 5 pl, and the maximum output resolution is 1200 dpi in both the main scanning direction (the direction perpendicular to the direction of movement of the intermediate transfer medium) and the sub-scanning direction (the direction of movement of the intermediate transfer medium). Droplets of the second treatment liquid are ejected onto the whole surface of the image forming region of the intermediate transfer medium 116.

When droplets of the second treatment liquid have been ejected, an aggregating action occurs in the ink which has not yet reacted, and the ink separates into aggregate (dots) and solvent on the intermediate transfer medium 116.

When the ink separates into an aggregate and solvent on the intermediate transfer medium 116, the solvent on the intermediate transfer medium 116 is removed by the solvent removal unit 118. In the inkjet recording apparatus 100 shown in the present embodiment, the standard time required from the ejection of droplets of the second treatment liquid until removal of solvent is set to 50 seconds.

A desirable mode is one where the time period required from ejection of droplets of the second treatment liquid until removal of solvent is set in accordance with the contents of the image. For example, if an image having a low recording density, such as text, is to be printed (if the total droplet ejection volume of the ink is smaller than a prescribed amount), then it is possible to shorten the reaction time between the second treatment liquid and the ink, and hence a desirable mode is one where the time period required from ejection of droplets of the second treatment liquid until removal of solvent is shortened by increasing the speed of conveyance of the intermediate transfer medium 116.

The solvent removal unit 118 shown in FIG. 7 comprises an absorbing roller 118A having a surface made of a porous member, and brings this absorbing roller 118A which rotates idly with the movement of the intermediate transfer medium 116 into contact with the solvent on the intermediate transfer medium 116, thereby absorbing and removing the solvent. The absorbing roller 118A is composed so as to be movable in the vertical direction in FIG. 7, in such a manner that it can be abutted against and separated from the image forming surface of the intermediate transfer medium 116. Furthermore, the surface area of the absorbing roller 118A (the area of the surface which makes contact with the intermediate transfer medium 116) corresponds to the maximum image size.

The surface energy γ_{c} of the surface of the absorbing roller 118A (the surface which makes contact with the image forming surface of the intermediate transfer medium) is desirably smaller than the surface energy γₐ₂ of the image forming surface of the intermediate transfer body 116 (γ_{c}<γₐ₂), and in the present embodiment, the absorbing roller 118A uses a member which has a surface energy γ_{c} of 30 mN/m or lower.

By removing solvent by using the absorbing roller 118A described above, adherence of ink aggregate to the absorbing roller 118A is prevented and it is possible to remove only the solvent on the intermediate transfer medium 116. As a further mode of the solvent removal unit 118, it is possible to use a method which removes the excess solvent on the intermediate transfer medium 116 by means of an air knife instead of an absorbing roller 118A, or a method which drives off and removes the solvent by heating the intermediate transfer medium 116.

In a mode where the solvent on the image forming surface of the intermediate transfer medium 116 is removed by means of an absorbing roller 118A, even in cases where a large amount (excessive amount) of aggregating treatment liquid is deposited on the image forming surface of the intermediate transfer medium 116, since the solvent on the intermediate transfer medium 116 is removed reliably, then a large amount of solvent (dispersion medium) is not transferred to the recording medium 122 during the transfer recording action. Consequently, even in cases where paper is used as the recording medium 122 (and in particular, paper such as normal paper, which has permeable properties), there is no occurrence of the problems which are typical of water-based solvents, such as curl, cockling, or the like.

Moreover, by removing the excess solvent on the ink aggregate by using the solvent removal unit 118, the aggregate is condensed and the internal aggregating force is enhanced yet further. By this means, it is possible to impart a stronger internal aggregating force to the ink aggregate by the time of the transfer recording step performed by the transfer recording unit 126. Moreover, by achieving effective condensation of the ink aggregate by removal of the solvent, it is possible to apply good fixing properties and good luster to the image, even after transfer of the image to the recording medium 122.

It is not absolutely necessary to remove all of the solvent on the intermediate transfer medium 116 by means of this solvent removal unit 118. If the ink aggregate is condensed excessively by removing an excessive amount of solvent, then the aggregating force between the ink aggregate and the transfer body becomes too strong, and therefore a very large pressure is needed for transfer, which is not desirable. Rather, in order to maintain a ductility which is suitable for transfer, it is desirable to leave a small amount of solvent.

The following beneficial effects are obtained by leaving a small amount of solvent on the intermediate transfer medium 116. Specifically, since the ink aggregate is hydrophobic, and the non-volatile solvent component (principally, the organic solvent, such as glycerine) is hydrophilic, then the ink aggregate and the residual solvent component separate after carrying out solvent removal, and a thin layer of liquid composed of the residual solvent component is formed between the ink aggregate and the intermediate transfer medium. Consequently, the adhesive force of the ink aggregate on the intermediate transfer medium 116 becomes weak, which is beneficial for improving transfer characteristics.

The removal of solvent described above can be controlled by altering the pressing force applied to the intermediate transfer medium 116 by the absorbing roller 118A. If the amount of solvent to be removed is relatively large, then the pressing force of the absorbing roller 118A against the intermediate transfer medium 116 should be raised, and if the amount of solvent to be removed is relatively small, then the pressing force of the absorbing roller 118A against the intermediate transfer medium 116 should be lowered.

Moreover, it is also possible to adopt a mode in which a plurality of absorbing rollers having different absorption characteristics are provided, and the absorbing roller used is changed selectively in accordance with the amount of solvent to be removed.

When the solvent removal step has been completed, a preheating process is carried out on the intermediate transfer medium 116 by the heater 120. A plate heater is suitable for use as the heater 120. FIG. 7 shows a mode where the heater 120 is provided externally to the intermediate transfer medium 116, but it is also possible to incorporate the heater 120 into the intermediate transfer medium 116.

When the solvent removal step performed by the solvent removal unit 118 has ended, the heater 120 is operated in such a manner that the surface temperature of the image forming region of the intermediate transfer medium 116 is equal to or higher than 50° C. and equal to or lower than 150° C.

Since at least one of the first treatment liquid, the second treatment liquid and the ink used in the inkjet recording apparatus 100 shown in the present embodiment contains resin micro-particles and polymer micro-particles, then by setting the heating temperature of the heater 120 to the softening temperature (glass transition temperature) of the resin micro-particles or the polymer micro-particles, it is possible to heat the intermediate transfer medium 116 and soften the image formed on the intermediate transfer medium 116, and since the image has a viscosity suited to transfer recording, then image deterioration during transfer recording is prevented, and the efficiency of the transfer recording step is improved.

When the intermediate transfer medium 116 is preheated to a prescribed temperature by the heater 120, then the intermediate transfer medium 116 and the recording medium 122 are pressed at a prescribed pressure in a sandwiched (interposed) state between the transfer roller 126A and the transfer roller 126B, and the primary image on the intermediate transfer medium 116 is transferred and recorded to the recording medium 122 (transfer recording step).

In other words, the transfer recording unit 126 comprises two transfer rollers 126A and 126B which are disposed on either side of the intermediate transfer medium 116, adopting a structure in which the transfer roller 126A is disposed on the image forming surface side of the intermediate transfer medium 116, while the transfer roller 126B is disposed on the opposite side to the image forming surface.

The recording medium 122 supplied from the paper supply unit 124 is sandwiched (interposed) between the intermediate transfer medium 116 and the transfer roller 126A, and while maintaining this state, a prescribed nip pressure (pressing force) is applied via the transfer roller 126A.

A desirable mode is one where, in the transfer step shown in the present embodiment, the prescribed nip pressure is 0.5 MPa to 3.0 MPa. As a device for adjusting the nip pressure during transfer and recording in the transfer and recording unit 126, it is possible to employ, for example, a mechanism (drive device) which moves the transfer rollers 126A and 126B in the vertical direction in FIG. 7. In other words, if the transfer rollers 126A and 126B are moved in a direction which increases the clearance between the transfer roller 126A and the transfer roller 126B, then the nip pressure becomes lower, and if the transfer roller 126A and the transfer roller 126B is moved in a direction which reduces the clearance between the transfer roller 126A and the transfer roller 126B, then the nip pressure becomes greater.

FIG. 7 shows a cassette in which cut paper is stacked and loaded, as one example of a paper supply unit 124, but it is also possible to use a plurality of cassettes conjointly, in accordance with recording media having different widths, qualities, and the like. Moreover, paper may also be supplied in cassettes which contain cut paper loaded in a stacked state, in lieu or of in combination with magazines for rolled paper (continuous paper).

In the case of a configuration in which a plurality of types of recording paper can be used, it is preferable that an information recording medium such as a bar code and a wireless tag containing information about the type of paper is attached to the cassette, and by reading the information contained in the information recording medium with a predetermined reading device, the type of recording medium to be used (type of medium) is automatically determined, and ink-droplet ejection is controlled so that the ink-droplets are ejected in an appropriate manner in accordance with the type of medium.

In the case of the configuration in which roll paper is used, a cutter is provided, and the continuous paper is cut into a desired size by the cutter. The cutter has a stationary blade, whose length is not less than the width of the conveyor pathway of the recording medium, and a round blade, which moves along the stationary blade. The stationary blade is disposed on the reverse side of the printed surface of the recording medium, and the round blade is disposed on the printed surface side across the conveyor pathway.

Furthermore, concrete examples of the recording medium 122 used in the present embodiment are: normal paper, permeable media, such as special inkjet paper, non-permeable media or low-permeability media, such as coated paper, sealed paper having adhesive or a detachable label on the rear surface thereof, a resin film, such as an OHP sheet, or a metal sheet, cloth, wood or other types of media.

When the transfer recording onto the recording medium 122 has been completed in the transfer recording unit 126, the recording medium 122 bearing the recorded image is separated from the intermediate transfer medium 116 in a separation unit 128, and the recording medium 122 is supplied to a fixing unit 130.

The separation unit 128 is composed in such a manner that the recording medium 122 becomes detached from the intermediate transfer medium 116 due to the rigidity (material strength) of the recording medium 122 and the bending curvature of the separating roller of the intermediate transfer medium 116. A device for promoting detachment, such as a separating hook, may also be used in the separation unit 128. A desirable mode is one where a cooling apparatus for cooling the recording medium 122 is provided between the separation unit 128 and the fixing unit 130.

Possible examples of a cooling apparatus are a composition where a fan is provided for blowing a cooling air onto the recording medium 122, or a composition where a cooling member, such as a peltiert element or heat sink, is provided.

In the fixing unit 130, heat and pressure are applied to the recording medium 122, and the image recorded on the recording medium 122 is fixed (fixing processing step).

The fixing unit 130 is, for example, constituted by a pair of heating rollers in which the temperature can be adjusted in the range of 50° C. to 200° C. A desirable mode is one where the heating temperature of the fixing unit 130 is 130° C., and the pressure is 0.5 MPa to 3.0 MPa. The heating temperature of the fixing unit 130 should be set in accordance with the glass transition temperature of the polymer micro-particles contained in the ink, or the like.

In the present embodiment, at least one of the first treatment liquid, the second treatment liquid and the ink contains resin micro-particles or polymer micro-particles, and by forming these micro-particles into a film (namely, creating a thin film of dissolved micro-particles on the outermost surface of the image), then it is possible to improve the fixing characteristics and the rubbing resistance of the image. Since both transfer properties and film manufacturing characteristics can be achieved in the transfer step in the transfer unit 126, then it is also possible to adopt a mode in which the fixing unit 130 is omitted.

When the fixing treatment step has been completed, the recording medium 122 bearing the recorded image is output to the exterior of the apparatus (the output direction is indicated by the arrow B). Although not shown in the drawings, a desirable mode is one where a collection tray is provided for accommodating the recording media 122 output to the exterior of the apparatus.

After completing the transfer recording step onto the recording medium 122, the intermediate transfer medium 116 is subjected to a cleaning process by the cleaning unit 134. The cleaning unit 134 comprises a blade (not illustrated) which wipes and removes the residual ink aggregate while abutting against the image forming surface of the intermediate transfer medium 116, and a recovery unit (not illustrated) which recovers the residual ink aggregate that has been removed. The composition of the cleaning device which removes the residual ink from the intermediate transfer medium 116 is not limited to the example given above, and it is also possible to adopt a system based on nipping a brush roller or water-absorbing roller, or the like, an air blower system which blows clean air, an adhesive roller system, or a combination of these systems. In the case of the configuration of nipping with the cleaning roller, it is preferable to make the linear velocity of the cleaning roller different to that of the belt, in order to improve the cleaning effect.

### Description of Print Unit

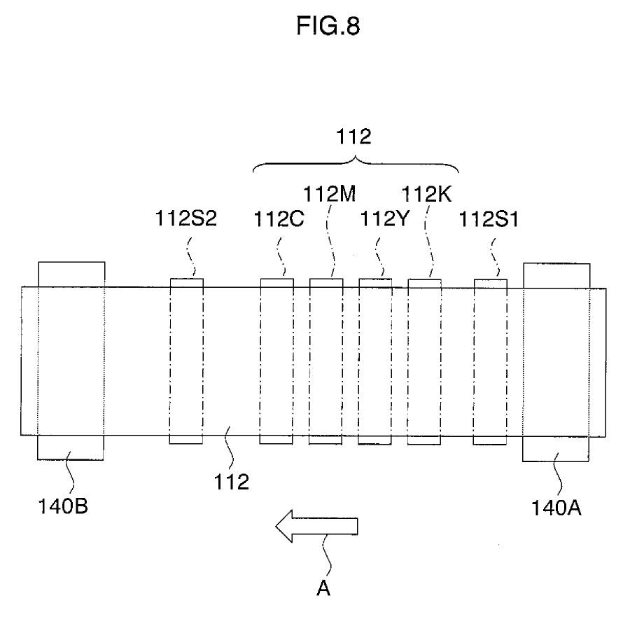

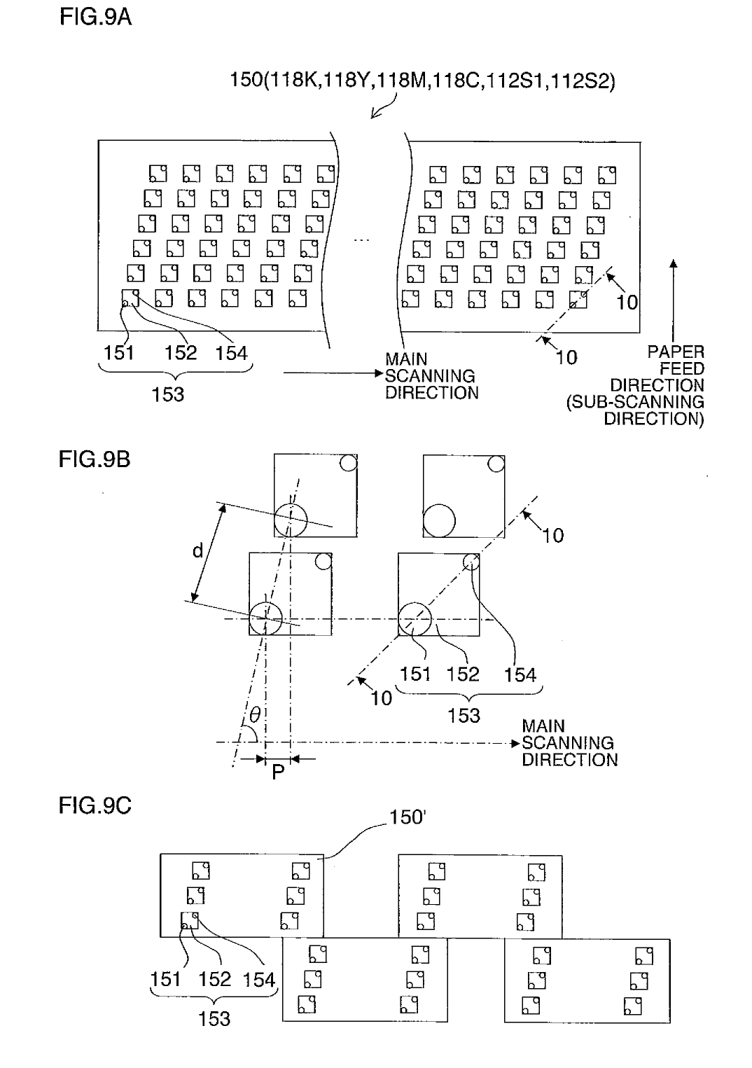

Next, the print unit 112 shown in FIG. 7 will be described in detail. The heads 112K, 112Y, 112M and 112C of the print unit 112 are each full-line heads having a length corresponding to the maximum width of the image forming region of the intermediate transfer medium 116 (see FIG. 8), and having a plurality of nozzles for ejecting ink (not shown in FIG. 8 and indicated by reference numeral 151 in FIGS. 9A to 9C) arranged through the full width of the image forming region.

The inkjet heads 112K, 112Y, 112M and 112C are disposed in the color order, black (K), cyan (C), magenta (M), yellow (Y), from the upstream side following the direction of movement of the intermediate transfer medium 116 (indicated by the white arrow in FIG. 8), and the respective heads 112K, 112Y, 112M and 112C are fixed so as to extend in the direction perpendicular to the direction of movement of the intermediate transfer medium 116.

By adopting a configuration in which full line heads having nozzle rows covering the full width of the intermediate transfer medium 116 are provided for each color of ink and treatment liquid, it is possible to record a primary image on the image forming region of the intermediate transfer medium 116 by performing just one operation of moving the intermediate transfer medium 116 and the print unit 112, relatively, in the direction of movement of the intermediate transfer medium 116 (the sub-scanning direction, see FIGS. 9A to 9C), (in other words, by means of one sub-scanning action). Accordingly, it is possible to achieve higher speed printing compared to a serial (shuttle) type of head in which the inkjet heads 112K, 112Y, 112M and 112C are moved back and forth reciprocally in the main scanning direction (see FIGS. 9A and 9B) which is perpendicular to the direction of movement of the intermediate transfer medium 116, and therefore the print productivity can be improved.

Although the configuration with the KCMY four standard colors is described in the present embodiment, combinations of the ink colors and the number of colors are not limited to those. Light inks, dark inks or special color inks can be added as required. For example, a configuration is possible in which ink heads for ejecting light-colored inks such as light cyan and light magenta are added, and furthermore, there are no particular restrictions of the sequence in which the heads of respective colors are arranged. Furthermore if using a plurality of different types of aggregating treatment liquid which have different viscosities and other conditions, then it is also possible to adopt a mode in which a plurality of treatment liquid deposition units (application rollers 136) are provided for each type of treatment liquid.

### Structure of the Head

Next, the structure of the inkjet heads 112K, 112Y, 112M and 112C and the first treatment liquid head 112S1 and the second treatment liquid head 11282 shown in FIG. 8 will be described. The inkjet heads 112K, 112Y, 112M and 112C and the first treatment liquid head 112S1 and the second treatment liquid head 112S2 have the same structure, and therefore these heads are represented below a head indicated by the reference numeral 150.

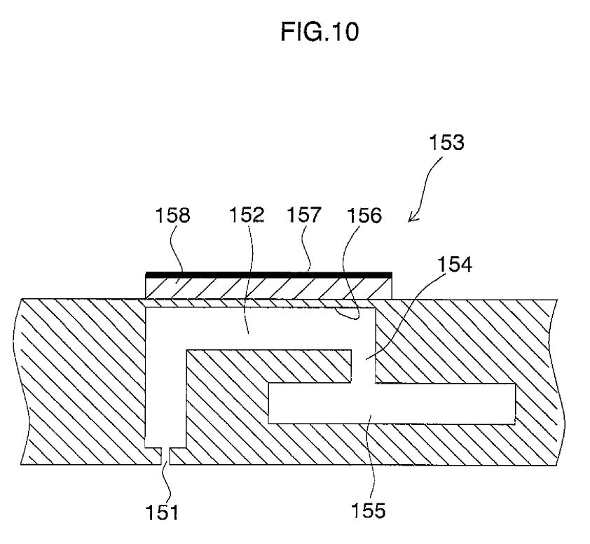

FIG. 9A is a perspective plan view showing an example of the configuration of the head 150, FIG. 9B is an enlarged view of a portion thereof, FIG. 9C is a perspective plan view showing another example of the configuration of the head 150, and FIG. 10 is a cross-sectional view taken along the line 10-10 in FIGS. 9A and 9B.

The nozzle pitch in the head 150 should be minimized in order to maximize the density of the dots formed on the surface of the intermediate transfer medium 116. As shown in FIGS. 9A and 9B, the head 150 according to the present embodiment has a structure in which a plurality of ink chamber units 153, each comprising a nozzle 151 forming an ink droplet ejection hole, a pressure chamber 152 corresponding to the nozzle 151, and the like, are disposed two-dimensionally in the form of a staggered matrix, and hence the effective nozzle interval (the projected nozzle pitch) as projected in the lengthwise direction of the head (the sub-scanning direction perpendicular to the paper conveyance direction) is reduced and high nozzle density is achieved.

The mode of forming one or more nozzle rows through a length corresponding to the entire width of the intermediate transfer medium 116 in a direction substantially perpendicular to the movement direction of the intermediate transfer medium 116 is not limited to the example described above. For example, instead of the configuration in FIG. 9A, as shown in FIG. 9C, a line head having nozzle rows of a length corresponding to the entire width of the intermediate transfer medium 116 can be formed by arranging and combining, in a staggered matrix, short head blocks 150′ having a plurality of nozzles 151 arrayed in a two-dimensional fashion. Furthermore, although not shown in the drawings, it is also possible to compose a line head by arranging short heads in one row.

The planar shape of the pressure chamber 152 provided for each nozzle 151 is substantially a square, and the nozzle 151 and the supply port 154 are disposed in both corners on a diagonal line of the square. Each pressure chamber 152 is connected to a common channel 155 through the supply port 154. The common channel 155 is connected to an ink supply tank (not shown in FIG. 7 and indicated by reference numeral 160 in FIG. 11), which is a base tank that supplies ink, and the ink supplied from the ink supply tank is delivered through the common flow channel 155 in FIG. 10 to the pressure chambers 152.

A piezoelectric element 158 provided with an individual electrode 157 is bonded to a diaphragm 156 which forms the upper face of the pressure chamber 152 and also serves as a common electrode, and the piezoelectric element 158 is deformed when a drive voltage is supplied to the individual electrode 157, thereby causing ink to be ejected from the nozzle 151. When ink is ejected, new ink is supplied to the pressure chamber 152 from the common flow passage 155, via the supply port 154.

In the present example, a piezoelectric element 158 was used as an ink ejection force generating device which causes ink to be ejected from a nozzle 150 provided in a head 151, but it is also possible to employ a thermal method in which a heater is provided inside the pressure chamber 152 and ink is ejected by using the pressure of the film boiling action caused by the heating action of this heater.

As shown in FIG. 9B, the high-density nozzle head according to the present embodiment is achieved by arranging a plurality of ink chamber units 153 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which a plurality of ink chamber units 153 are arranged at a uniform pitch d in line with a direction forming an angle of θ with respect to the main scanning direction, the pitch P of the nozzles projected so as to align in the main scanning direction is d×cos θ, and hence the nozzles 151 can be regarded to be equivalent to those arranged linearly at a fixed pitch P along the main scanning direction. Such configuration results in a nozzle structure in which the nozzle row projected in the main scanning direction has a high nozzle density of up to 2,400 nozzles per inch.

When implementing the present invention, the arrangement structure of the nozzles is not limited to the example shown in the drawings, and it is also possible to apply various other types of nozzle arrangements, such as an arrangement structure having one nozzle row in the sub-scanning direction.

Furthermore, the scope of application of the present invention is not limited to a printing system based on a line type of head, and it is also possible to adopt a serial system where a short head which is shorter than the breadthways dimension of the intermediate transfer medium 116 is scanned in the breadthways direction of the intermediate transfer medium 116, thereby performing printing in the breadthways direction, and when one printing action in the breadthways direction has been completed, the intermediate transfer medium 116 is moved through a prescribed amount in the direction perpendicular to the breadthways direction, printing in the breadthways direction of the intermediate transfer medium 116 is carried out in the next printing region, and by repeating this sequence, printing is performed over the whole surface of the printing region of the intermediate transfer medium 116.

### Configuration of a Supply System

FIG. 11 is a schematic drawing showing the configuration of the ink supply system in the inkjet recording apparatus 100.

The ink supply tank 160 is a base tank that supplies ink to the head 150 and is included in the ink storing and loading unit 114 described with reference to FIG. 7. The aspects of the ink supply tank 160 include a refillable type and a cartridge type: when the remaining amount of ink is low, the ink tank 160 of the refillable type is filled with ink through a filling port (not shown) and the ink tank 160 of the cartridge type is replaced with a new one. In order to change the ink type in accordance with the intended application, the cartridge type is suitable, and it is preferable to represent the ink type information with a bar code or the like on the cartridge, and to perform ejection control in accordance with the ink type.

A filter 162 for removing foreign matters and bubbles is disposed between the ink supply tank 160 and the head 150 as shown in FIG. 11. The filter mesh size in the filter 162 is preferably equivalent to or less than the diameter of the nozzle and commonly about 20 μm.

Although not shown in FIG. 11, it is preferable to provide a sub-tank integrally to the print head 150 or nearby the head 150. The sub-tank has a damper function for preventing variation in the internal pressure of the head and a function for improving refilling of the print head.

The inkjet recording apparatus 100 is also provided with a cap 164 as a device to prevent the nozzles 151 from drying out or to prevent an increase in the ink viscosity in the vicinity of the nozzles 151, and a cleaning blade 166 as a device to clean the ink ejection face of the head 150.

A maintenance unit including the cap 164 and the cleaning blade 166 can be relatively moved with respect to the head 150 by a movement mechanism (not shown), and is moved from a predetermined holding position to a maintenance position below the head 150 as required.

The cap 164 is displaced up and down relatively with respect to the head 150 by an elevator mechanism (not shown). When the power of the inkjet recording apparatus 100 is turned OFF or when in a print standby state, the cap 164 is raised to a predetermined elevated position so as to come into close contact with the head 150, and the nozzle face is thereby covered with the cap 164.

During printing or standby, if the use frequency of a particular nozzle 151 is low, and if a state of not ejecting ink continues for a prescribed time period or more, then the solvent of the ink in the vicinity of the nozzle evaporates and the viscosity of the ink increases. In a situation of this kind, it will become impossible to eject ink from the nozzle 151, even if the piezoelectric element 158 is operated.

Therefore, before a situation of this kind develops (namely, while the ink is within a range of viscosity which allows it to be ejected by operation of the piezoelectric element 158), the piezoelectric element 158 is operated, and a preliminary ejection (“purge”, “blank ejection”, “liquid ejection” or “dummy ejection”) is carried out toward the cap 164 (ink receptacle), in order to expel the degraded ink (namely, the ink in the vicinity of the nozzle which has increased viscosity).

It is also possible to adopt a mode in which preliminary ejection is performed by ejecting droplets of ink toward the intermediate transfer medium 116. For example, if a plurality of images are formed in a continuous fashion, then it is possible to carry out preliminary ejection between the images. In particular, when a plurality of copies of the same image are formed, then the frequency of ejection of ink (treatment liquid) becomes low in particular nozzles, and there is an increased possibility that ejection abnormalities will occur; therefore, it is desirable to carry out preliminary ejection between images in respect of these particular nozzles.

If preliminary ejection is carried out onto the intermediate transfer medium 116, then the absorbing roller 118A and the transfer roller 126A are moved in such a manner that the ink (treatment liquid) ejected by the preliminary ejection does not adhere to the absorbing roller 118A or the transfer roller 126A, and a prescribed clearance (for example, approximately 10 mm) should be provided between the absorbing roller 118A, the transfer roller 126A, and the intermediate transfer medium 116.

Furthermore, if air bubbles enter into the ink inside the head 150 (inside the pressure chamber 152), then even if the piezoelectric element 158 is operated, it will not be possible to eject ink from the nozzle. In a case of this kind, the cap 164 is placed on the head 150, the ink (ink containing air bubbles) inside the pressure chamber 152 is removed by suction, by means of a suction pump 167, and the ink removed by suction is then supplied to a recovery tank 168.

This suction operation is also carried out in order to remove degraded ink having increased viscosity (hardened ink), when ink is loaded into the head for the first time, and when the head starts to be used after having been out of use for a long period of time. Since the suction operation is carried out with respect to all of the ink inside the pressure chamber 152, the ink consumption is considerably large. Therefore, desirably, preliminary ejection is carried out when the increase in the viscosity of the ink is still minor.

The cleaning blade 166 is composed of rubber or another elastic member, and can slide on the ink ejection surface of the head 150 by means of a blade movement mechanism (not illustrated). If ink droplets or foreign material become attached to the ink ejection surface, then the ink ejection surface is wiped and thereby cleaned, by moving the cleaning blade 166 over the ink ejection surface.

In an inkjet recording apparatus which uses a transfer recording method, it is also possible to carry out preliminary ejection onto the intermediate transfer medium 116 (see FIG. 7). For example, if preliminary ejection is carried out between images, then by using the intermediate transfer medium 116 as an ink receptacle, the time required for moving the cap 164 to a position directly below the print unit 112 (see FIG. 7) or the time required to withdraw the intermediate transfer medium 116 from directly below the print unit 112 can be saved, and therefore the time required for preliminary ejection can be shortened. Moreover, it is also possible to clean the ink adhering to the intermediate transfer medium 116 due to preliminary ejection, by means of the cleaning unit 134. If preliminary ejection is performed onto the intermediate transfer medium 116, then the transfer roller 126B should be separated from the intermediate transfer medium 116 in order to prevent the transfer roller 126B from becoming soiled with ink.

### Description of Control System

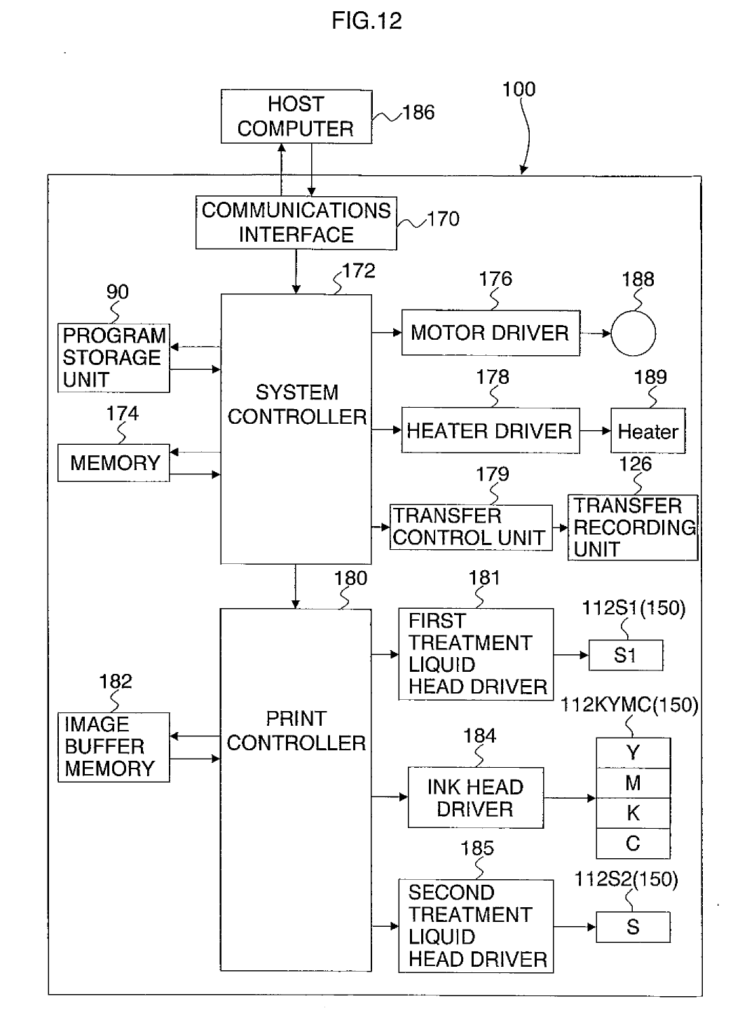

FIG. 12 is a principal block diagram showing the system configuration of the inkjet recording apparatus 100. The inkjet recording apparatus 100 comprises a communication interface 170, a system controller 172, a memory 174, a motor driver 176, a heater driver 178, a print controller 180, an image buffer memory 182, an ink head driver 184, and the like.

The communication interface 170 is an interface unit for receiving image data sent from a host computer 186. A serial interface such as USB (Universal Serial Bus), IEEE1394, Ethernet (registered trademark), wireless network, or a parallel interface such as a Centronics interface may be used as the communication interface 170. A buffer memory (not shown) may be mounted in this portion in order to increase the communication speed. The image data sent from the host computer 186 is received by the inkjet recording apparatus 100 through the communication interface 170, and is temporarily stored in the memory 174.

The memory 174 is a storage device for temporarily storing images inputted through the communication interface 170, and data is written and read to and from the memory 174 through the system controller 172. The memory 174 is not limited to a memory composed of semiconductor elements, and a hard disk drive or another magnetic medium may be used.

The system controller 172 is constituted by a central processing unit (CPU) and peripheral circuits thereof, and the like, and it functions as a control device for controlling the whole of the inkjet recording apparatus 100 in accordance with a prescribed program, as well as a calculation device for performing various calculations. More specifically, the system controller 172 controls the various sections, such as the communication interface 170, memory 174, motor driver 176, heater driver 178, and the like, as well as controlling communications with the host computer 186 and writing and reading to and from the memory 174, and it also generates control signals for controlling the motor 188 and heater 189 of the conveyance system.

The program executed by the CPU of the system controller 172 and the various types of data which are required for control procedures are stored in the memory 174. The memory 174 may be a non-writeable storage device, or it may be a rewriteable storage device, such as an EEPROM. The memory 174 is used as a temporary storage region for the image data, and it is also used as a program development region and a calculation work region for the CPU.

The motor driver 176 is a driver which drives the motor 188 in accordance with instructions from the system controller 172. In FIG. 12, the motors (actuators) disposed in the respective sections of the apparatus are represented by the reference numeral 188. For example, the motor 188 shown in FIG. 12 comprises a motor which drives the drive rollers in the tensioning rollers 140A to 140G in FIG. 7, a motor of the movement mechanism of the absorbing roller 118A, a motor of the movement mechanisms of the transfer rollers 126A and 126B, and the like.

The heater driver 178 is a driver which drives the heater 189 in accordance with instructions from the system controller 172. In FIG. 12, the plurality of heaters which are provided in the inkjet recording apparatus 100 are represented by the reference numeral 89. For example, the heater 189 shown in FIG. 12 includes the heater 120 shown in FIG. 7, and the pair of heating rollers in the fixing unit 49, and the like.

The transfer control unit 179 controls the pressing force of the transfer rollers 126A and 126B in the transfer recording unit 126 shown in FIG. 7. The optimal value for the pressing force of the transfer rollers 126A and 126B is previously determined for each type of recording medium 122 and each type of ink, and this data is stored in a prescribed memory (for example, a memory 174) in the form of a data table. When information about the recording medium 122 or information about the ink used has been acquired, the pressing force of the transfer rollers 126A and 126B is controlled accordingly by referring to the memory.

The print controller 180 has a signal processing function for performing various tasks, compensations, and other types of processing for generating print control signals from the image data stored in the memory 174 in accordance with commands from the system controller 172 so as to supply the generated print data (dot data) to the ink head driver 184. Prescribed signal processing is carried out in the print controller 180, and the ejection amount and the ejection timing of the ink droplets from the respective print heads 150 are controlled via the ink head driver 184, on the basis of the print data. By this means, prescribed dot size and dot positions can be achieved.

Furthermore, the print controller 180 has a signal processing function for carrying out various treatments and corrections, and the like, in order to generate signals for controlling the first treatment liquid head and the second treatment liquid head on the basis of the image data; the generated droplet ejection data (dot data) is supplied to the first treatment liquid head driver 181 and the second treatment liquid head driver 185, and the ejection volume and ejection timing of the first treatment liquid head 112S1, and the ejection volume and the ejection timing of the second treatment liquid head 112S2 are controlled accordingly via the first treatment liquid head driver 181 and the second treatment liquid head driver 185.

The print controller 180 is provided with the image buffer memory 182; and image data, parameters, and other data are temporarily stored in the image buffer memory 182 when image data is processed in the print controller 180. Also possible is an aspect in which the print controller 180 and the system controller 172 are integrated to form a single processor.

The ink head driver 184 generates drive signals to be applied to the piezoelectric elements 158 of the head 150 (the inkjet heads 112K, 112Y, 112M 112C), on the basis of image data supplied from the print controller 180, and also comprises drive circuits which drive the piezoelectric elements 158 by applying the drive signals to the piezoelectric elements 158. A feedback control system for maintaining constant drive conditions in the head 150 may be included in the inkjet head driver 184 shown in FIG. 12.

Furthermore, the first treatment liquid head driver 181 generates drive signals to be applied to the piezoelectric elements 158 of the first treatment liquid head 112S1, on the basis of the treatment liquid data supplied from the print controller 180, and also comprises drive circuits which drive the piezoelectric elements 158 by applying the drive signals to the piezoelectric elements 158. Similarly, the second treatment liquid head driver 185 generates drive signals to be applied to the piezoelectric elements 158 of the second treatment liquid head 112S2, on the basis of the treatment liquid data supplied from the print controller 180, and also comprises drive circuits which drive the piezoelectric elements 158 by applying the drive signals to the piezoelectric elements 158.

The image data to be printed is externally inputted through the communication interface 170, and is stored in the memory 174. In this stage, the RGB image data is stored in the memory 174.

The image data stored in the memory 174 is sent to the print controller 180 through the system controller 172, and is converted to the dot data for the respective ink colors and dot data for the second treatment liquid in the print controller 180. In other words, the print controller 180 performs processing for converting the inputted RGB image data into dot data for four colors, K, C, M and Y The dot data generated by the print controller 180 is stored in the image buffer memory 182.

The primary image formed on the intermediate transfer medium 116 must be a mirror image of the secondary image (recorded image) which is to be formed finally on the recording medium 122, taking account of the fact that it is reversed when transferred onto the recording medium. In other words, the drive signals supplied to the inkjet heads 112K, 112Y, 112M and 112C are drive signals corresponding to a mirror image, and therefore the input image must be subjected to reversal processing by the print controller 180.

Various control programs are stored in a program storage section 190, and a control program is read out and executed in accordance with commands from the system controller 172. The program storage section 190 may use a semiconductor memory, such as a ROM, EEPROM, or a magnetic disk, or the like. An external interface may be provided, and a memory card or PC card may also be used. Naturally, a plurality of these storage media may also be provided. The program storage section 190 may also be combined with a storage device for storing operational parameters, and the like (not shown).

### Another Example of the Apparatus

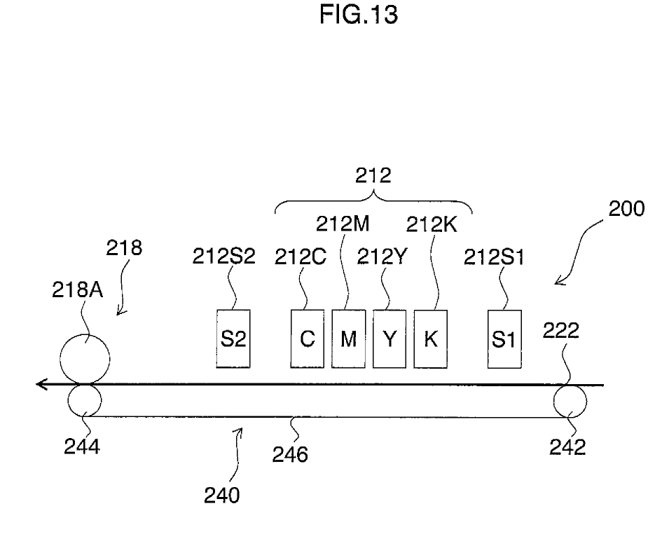

Next, another of an apparatus to which the present invention is applied will be described. FIG. 13 is a general schematic drawing of an inkjet recording apparatus 200. The image recording apparatus 200 shown in FIG. 13 employs a direct recording method in which an image is formed directly onto a recording medium 222.

The inkjet recording apparatus 200 comprises: a first treatment liquid head 212S1 which ejects (deposits) droplets of a first treatment liquid onto the recording medium 222; a print unit 212 including heads 212K, 212C, 212M and 212Y which eject droplets of inks of the respective colors of KYMC onto the recording medium 222 on which droplets of the first treatment liquid have been ejected; a second treatment liquid head 212S2 which ejects droplets of a second treatment liquid after the ejection of droplets of the inks of respective colors of KYMC; and a solvent removal unit 218 including an absorbing roller 218A which removes solvent component remaining on the recording medium 222.

The recording medium 222 which is output from the paper supply unit (not illustrated) is supplied to a suction belt conveyance unit 240. The suction belt conveyance unit 240 has a structure in which an endless belt 246 is wound about rollers 242 and 244, and at least the portion thereof which opposes the first treatment liquid head 212S1, the print unit 212, the second treatment liquid head 212S2 and the solvent removal unit 218 forms a horizontal surface (flat surface).

The belt 246 has a greater width than the recording medium 222, and a plurality of suction apertures (not illustrated) are formed in the belt surface. As shown in FIG. 13, the suction chamber (not illustrated) is provided on the inner side of the belt 246 which is wound about the rollers 242 and 244 (the roller 244 also serves as a supporting roller for the flattening process unit 223), at a position opposing the treatment liquid deposition unit 238, the print 212, the solvent removal unit 218 and the flattening process unit 223. The recording medium 222 is suctioned and held on the belt 246 by creating a negative pressure by suctioning the suction chamber with a pump (not illustrated).

By transmitting the motive force of a motor (not illustrated in FIG. 13 and represented by reference numeral 188 in FIG. 12) to at least one of the rollers 242, 244 on which the belt 246 is wound, the belt 246 is driven in the counterclockwise direction in FIG. 13 and the recording medium 222 held on the belt 246 is conveyed from right to left in FIG. 13.

Since ink adheres to the belt 246 when a marginless print job or the like is performed, a belt-cleaning unit (not shown) is disposed in a predetermined position (a suitable position outside the printing area) on the exterior side of the belt 246. Although the details of the configuration of the belt-cleaning unit (not shown) are not shown, examples thereof include a configuration in which the belt 246 is nipped with cleaning rollers such as a brush roller and a water absorbent roller, an air blow configuration in which clean air is blown onto the belt 246, or a combination of these. In the case of the configuration in which the bell 246 is nipped with the cleaning rollers, it is preferable to make the line velocity of the cleaning rollers different than that of the belt 246 to improve the cleaning effect.

The inkjet recording apparatus 200 can comprise a roller nip conveyance mechanism, in which the recording paper is pinched and conveyed with nip rollers, instead of the suction belt conveyance unit 240. However, there is a drawback in the roller nip conveyance mechanism that the print tends to be blurred when the printing area is conveyed by the roller nip action because the nip roller makes contact with the printed surface of the paper immediately after printing. Therefore, the suction belt conveyance in which nothing comes into contact with the image surface in the printing area is preferable.

It is also possible to use a composition which comprises an application roller or a blade instead of the first treatment liquid head 212S1. The composition shown in FIG. 11 and FIG. 12 is employed in the ink supply system of the inkjet recording apparatus 200 and the maintenance mechanism and control system of the heads 212K, 212C, 212M and 212Y shown in FIG. 13.

The constituent elements which are omitted from the illustration in FIG. 13 include: a decurling unit which removes curl in the recording medium 222 supplied form the paper supply unit; a cutter which cuts the recording medium to a prescribed size if a long recording medium (roll-shaped recording medium) is used; a beater which heats the recording medium 222, and the like.

The inkjet recording apparatus 200 shown in FIG. 13 has particularly beneficial effects when using a medium having non-permeable properties (non-permeable medium) as the recording medium 222 with respect to the aggregating treatment liquid and ink. To give possible examples of a non-permeable medium, there are coated paper, resin films, such as OHP film, metal sheet, and the like. The applicability of the recording medium 222 is not limited to a medium having non-permeable properties, and it is also possible to use a medium having poor permeability compared to a medium having permeable properties, such as normal paper.

An inkjet recording apparatus which records images on a recording medium by using ink droplets was described as an example of an apparatus according to the present invention, but the range of application of the present invention is not limited to an inkjet recording apparatus. For example, it may also be applied widely to an image forming apparatus which forms a mouse pattern by means of a resin liquid (resist layer) on a substrate, or a liquid ejection apparatus which ejects a liquid such as water or a liquid chemical, patterns this liquid to a prescribed shape, and then deposits same on a substrate.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming method of forming an image on an image forming body according to image data, the image is being formed by using an ink liquid containing a coloring material, the image forming method comprising the steps of:
applying a first treatment liquid onto the image forming body, the first treatment liquid having a first pH that is lower than an aggregation pH of the ink liquid;
after the step of applying the first treatment liquid, depositing droplets of the ink liquid onto the image forming body on which the first treatment liquid has been applied, the droplets of the ink liquid being deposited according to the image data;
after the step of depositing the droplets of the ink liquid, applying a second treatment liquid onto the image forming body on which the droplets of the ink liquid have been deposited, the second treatment liquid having a second pH that is lower than the aggregation pH of the ink liquid and lower than the first pH of the first treatment liquid; and
after the step of applying the second treatment liquid, removing solvent derived from the ink liquid on the image forming body.

2. The image forming method as defined in claim 1, wherein:
the first pH of the first treatment liquid is not lower than 5.0 and lower than 7.0; and
the second pH of the second treatment liquid is not lower than 3.0 and lower than 5.0.

3. The image forming method as defined in claim 1, wherein the second treatment liquid contains a polyvalent cationic reactive group.

4. The image forming method as defined in claim 1, wherein the ink liquid contains first particles and second particles dispersed therein, the first particles in the ink liquid aggregating when the ink liquid is in contact with the first treatment liquid, the second particles in the ink liquid aggregating when the ink liquid is in contact with the second treatment liquid.

5. The image forming method as defined in claim 1, further comprising the step of transferring the image on the image forming body onto a recording medium, after the step of removing the solvent.

6. An inkjet recording apparatus which forms an image on an image forming body according to image data, the image is being formed by using an ink liquid containing a coloring material, the inkjet recording apparatus comprising:
a first treatment liquid application device which applies a first treatment liquid onto the image forming body, the first treatment liquid having a first pH that is lower than an aggregation pH of the ink liquid;
an inkjet head which deposits droplets of the ink liquid onto the image forming body on which the first treatment liquid has been applied by the first treatment liquid application device, the droplets of the ink liquid being deposited according to the image data;
a second treatment liquid application device which applies a second treatment liquid onto the image forming body on which the droplets of the ink liquid have been deposited by the inkjet head, the second treatment liquid having a second pH that is lower than the aggregation pH of the ink liquid and lower than the first pH of the first treatment liquid; and
a solvent removal device which removes solvent derived from the ink liquid on the image forming body on which the second treatment liquid has been applied by the second treatment liquid application device.

7. The inkjet recording apparatus as defined in claim 6, wherein:
the first pH of the first treatment liquid applied by the first treatment liquid application device is not lower than 5.0 and lower than 7.0; and
the second pH of the second treatment liquid applied by the second treatment liquid application device is not lower than 3.0 and lower than 5.0.

8. The inkjet recording apparatus as defined in claim 6, further comprising a transfer device which transfers the image on the image forming body onto a recording medium, after the solvent on the image forming body has been removed by the solvent removal device.
